(19) United States
(12) Patent Application Publication
(10) Pub. No.: US 2026/0338021 A1
(43) Pub. Date: Oct. 29, 2026

(54) DOOR OPENING AND CLOSING DEVICE AND ELECTRICAL APPARATUS

(71) Applicants: HEFEI MIDEA REFRIGERATOR CO., LTD., HEFEI (CN); HEFEI HUALING CO., LTD., HEFEI (CN); MIDEA GROUP CO., LTD., FOSHAN (CN)

(72) Inventors: Bo PENG, HEFEI (CN); Zhuohua JIANG, HEFEI (CN); Yafei ZHU, HEFEI (CN); Yerui FENG, HEFEI (CN); Bing SHI, HEFEI (CN); Chuandong WANG, HEFEI (CN); Shenghao QI, HEFEI (CN); Jinguo YUAN, HEFEI (CN); Xiuliang FU, HEFEI (CN)

(21) Appl. No.: 19/111,775

(22) PCT Filed: Jun. 27, 2023
(86) PCT No.: PCT/CN2023/102679

§ 371 Date: Mar. 13, 2025

(30) Foreign Application Priority Data
Sep. 20, 2022 (CN) 202211145488.8

(51) Int. Cl. E05F 15/614; E05F 15/616

(52) U.S. Cl. CPC E05F 15/614; E05F 15/616; E05Y 2201/216; E05Y 2201/246; E05Y 2201/686; E05Y 2201/71

(57) ABSTRACT

A door opening and closing device includes a driving mechanism, a linkage gear, a clutch and a door rotation mechanism. The linkage gear is rotatably disposed on the base; The clutch is disposed between the driving mechanism and the linkage gear, and configured to selectively make the driving mechanism and the linkage gear in transmission connection. The door rotation mechanism, with an end connected to the linkage gear and another end connected to the door body. The door ejection mechanism is connected to the linkage gear and configured to push and eject the door body. Also provided is an electrical apparatus having the door opening and closing device. The door opening and closing device can at least to a certain extent solve a problem of difficulty in opening and closing the door body of the electrical apparatus and inconvenience in use.

### CROSS-REFERENCES TO RELATED APPLICATIONS

The present disclosure is a national phase application of International Application No. PCT/CN2023/102679, filed Jun. 27, 2023, which claims priority to the Chinese patent application No. 202211145488.8, filed on Sep. 20, 2022, the entire contents of which are incorporated herein by reference.

### FIELD

The disclosure belongs to the field of electrical apparatus, and in particular to a door opening and closing device and an electrical apparatus.

### BACKGROUND

With the improvement of living standards, electrical apparatuses such as refrigerators, dishwashers and disinfection cabinets have become widely used in lives of people. In order to maintain a sealing performance of the above-mentioned electrical apparatuses, an adsorption structure is usually disposed between the box body and the door body of the electrical apparatus to maintain a negative pressure inside the box body, to stably fix the door body to the main body. Although a related performance of the electrical apparatus is improved in this way, a door-opening difficulty is also increased to a certain extent. Since a larger force is usually required to open the door body of the electrical apparatus, it is inconvenient to use.

### SUMMARY

A door opening and closing device and an electrical apparatus are provided according to one or more embodiments of the disclosure, which are intended to at least to some extent solve a problem of difficulty in opening and closing a door body of the electrical apparatus and inconvenience in use.

According to one embodiment of the disclosure, a door opening and closing device is provided, which includes a driving mechanism; a linkage gear rotatably disposed on the base; a clutch disposed between the driving mechanism and the linkage gear, and configured to selectively make the driving mechanism and the linkage gear in transmission connection; a door rotation mechanism, an end of which is connected to the linkage gear and another end of which is connected to the door body; and a door ejection mechanism connected to the linkage gear and configured to push and eject the door body; wherein, in a condition that the clutch makes the driving mechanism and the linkage gear in transmission connection and the driving mechanism drives the linkage gear to rotate, the linkage gear drives the door ejection mechanism to push the door body to push the door body open, and then drives the door rotation mechanism to continue to open the door body.

According to another embodiment of the disclosure, an electrical apparatus is provided, which includes a door body, a box body and a door opening and closing device. In a condition that the clutch establishes a transmission connection state of the linkage gear and the driving mechanism, the driving mechanism is able to drive the linkage gear to rotate, to drive the door ejection mechanism to eject the door body open, and then the door body is rotated by the door rotation mechanism.

### BRIEF DESCRIPTION OF THE DRAWINGS

In order to more clearly illustrate the one or more embodiments of the disclosure, the following briefly introduces the accompanying drawings required for describing the embodiments. The accompanying drawings in the following description only illustrate some embodiments of the disclosure, and other accompanying drawings can also be obtained based on these accompanying drawings.

FIG. 1 shows a schematic structural diagram of a door opening and closing device according to an embodiment of the disclosure;

FIG. 2 is a schematic structural diagram showing a door opening state of the door opening and closing device in FIG. 1;

FIG. 3 is a schematic assembly structural diagram of a clutch of the door opening and closing device in FIG. 1;

FIG. 4 shows an exploded view of a first structure of the clutch in FIG. 3;

FIG. 5 shows an exploded view of a second structure of the clutch in FIG. 3;

FIG. 6 shows an exploded view of the clutch in FIG. 5 from another viewing angle;

FIG. 7 shows a schematic structural diagram of a first transmission assembly of the clutch in FIG. 3;

FIG. 8 shows a schematic structural diagram of a second transmission assembly of the clutch in FIG. 3;

FIG. 9 shows a schematic structural diagram of a transmission connection assembly of the clutch in FIG. 3;

FIG. 10 shows a schematic structural diagram of an ejection-push sleeve of a clutch-ejection-push assembly of the clutch in FIG. 3;

FIG. 11 shows a schematic structural diagram of a push rod of the clutch-ejection-push assembly of the clutch in FIG. 3;

FIG. 12 shows a schematic assembly structural diagram of the clutch-ejection-push assembly of the clutch in FIG. 3;

FIG. 13 shows a schematic assembly diagram of the ejection-push sleeve of the clutch in FIG. 3;

FIG. 14 shows a schematic structural diagram of an anti-rotation mechanism of the clutch in FIG. 3;

FIG. 15 is a schematic diagram showing a first structure of a door ejection mechanism of the door opening and closing device in FIG. 1;

FIG. 16 is a schematic diagram showing a second structure of a door ejection mechanism of the door opening and closing device in FIG. 2;

FIG. 17 shows a schematic structural diagram of a suspension mechanism of the door opening and closing device in FIG. 1;

FIG. 18 is a schematic structural diagram of a linkage gear of the door opening and closing device in FIG. 17;

FIG. 19 is a schematic diagram showing a cooperation of a suspension member and an ejection-push member of the door opening and closing device in FIG. 17;

FIG. 20 shows a schematic structural diagram of a suspension limit slide groove of the door opening and closing device in FIG. 17;

FIG. 21 is a schematic diagram showing a cooperation of the suspension member and the suspension limit slide groove of the door opening and closing device in FIG. 17;

FIG. 22 is a schematic structural diagram showing an initial state of a door ejection mechanism of the door opening and closing device in FIG. 17;

FIG. 23 is a schematic structural diagram showing an ejection-push state of the door ejection mechanism of the door opening and closing device in FIG. 17;

FIG. 24 is a schematic structural diagram showing a suspended state of the door ejection mechanism of the door opening and closing device in FIG. 17;

FIG. 25 is a schematic structural diagram showing an initial state of another door ejection mechanism of the door opening and closing device in FIG. 1;

FIG. 26 is a schematic structural diagram showing an ejection-push state of another door ejection mechanism of the door opening and closing device in FIG. 25;

FIG. 27 is a schematic structural diagram showing a suspended state of another door ejection mechanism of the door opening and closing device in FIG. 25;

FIG. 28 is a schematic diagram showing a suspension structure of another suspension mechanism of the door opening and closing device in FIG. 1;

FIG. 29 is a schematic structural diagram of a limit mechanism of another suspension mechanism of the door opening and closing device in FIG. 28;

FIG. 30 is a schematic structural diagram showing an initial state of another suspension mechanism of the door opening and closing device in FIG. 28;

FIG. 31 is a schematic structural diagram showing a door ejection state of another suspension mechanism of the door opening and closing device in FIG. 28;

FIG. 32 is a schematic structural diagram showing a suspension state of another suspension mechanism of the door opening and closing device in FIG. 28; and

FIG. 33 shows a schematic structural diagram of a linkage gear of another suspension mechanism of the door opening and closing device in FIG. 28.

In the accompanying drawings, corresponding relationships between reference signs and component names are as follows:
12, box body; 13, door body;
100, driving mechanism; 110, driver; 120, output gear;
200, clutch; 210, first transmission assembly; 211, engaging groove; 212, first transmission gear; 220, second transmission assembly; 221, engaging hole; 222, second transmission gear; 230, transmission connection assembly; 231, connecting end; 2311, connecting arm; 232, ejection-push end; 2321, annular seat; 240, clutch-ejection-push assembly; 241, ejection-push sleeve; 2411, push-ejection portion; 2412, shaft sleeve portion; 2413, first ejection-push surface; 2414, anti-rotation slot; 242, push rod; 2421, second ejection-push surface; 2422, push arm; 2423, connecting portion; 243, linear driver; 244, shock-absorbing pad; 250, separation assembly; 251, first separation member; 252, second separation member; 253, elastic reset member; 260, stop assembly; 261, connecting member; 2611, connecting shaft; 262, lock member; 263, stop member; 2631, baffle;
300, linkage gear; 320, limit groove; 322, door ejection surface; 324, avoidance surface; 326, connection point; 328, transition surface; 350, door ejection portion; 351, door ejection point; 352, appearance surface; 360, installation groove; 361, first abutting-holding surface; 362, second abutting-holding surface;
400, door rotation mechanism; 410, front connecting rod; 420, rear connecting rod; 432, first connection point; 434, second connection point; 436, third connection point; 438, rotation center;
500, door ejection mechanism; 510, elastic member; 520, door ejection member;
600, suspension mechanism; 610, suspension member; 611, ejecting-abutting portion; 612, push-ejection limit slot; 620, ejection-push member; 630, suspension structure; 631, connecting portion; 632, suspension portion; 633, reinforcing rib plate; 640, limit mechanism; 641, guide plane; 642, limit portion; 643, retaining groove;
800, angle acquisition unit;
900, base; 906, suspension limit slide groove; 907, limit boss; 908, support groove; 909, boss portion; 912, mounting groove; 920, common rotating shaft; 921, support column; 922, rotating shaft column; 923, fastening through hole; 930, anti-rotation mechanism; 931, anti-rotation rib.

### DETAILED DESCRIPTION OF THE DISCLOSURE

The embodiments of the disclosure will be clearly and completely described below with reference to the accompanying drawings. The described embodiments are only some embodiments, rather than all embodiments of the disclosure.

Furthermore, the disclosure may repeat reference numerals and/or reference letters in different examples. Such repetition is for the purpose of simplicity and clarity and does not in itself indicate a relationship between the various embodiments and/or settings discussed.

Furthermore, the disclosure provides examples of various specific processes and materials, but recognition of the application of other processes and/or the use of other materials.

One embodiment of the disclosure is described below with reference to the accompanying drawings and embodiments.

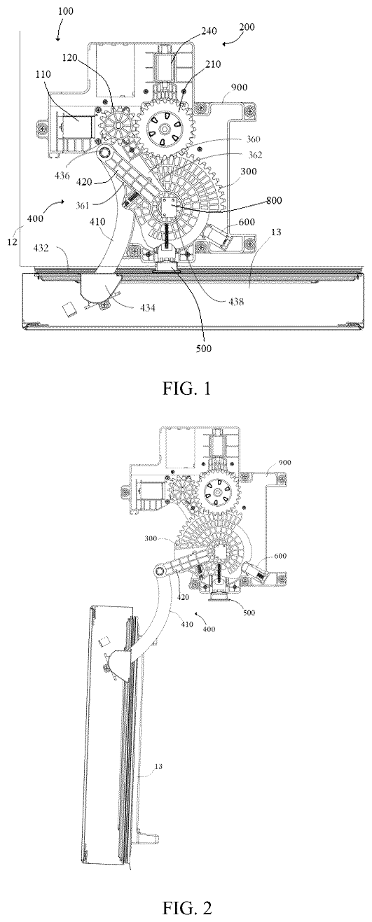

As shown in FIG. 1 and FIG. 2, according to one or more embodiments of the disclosure, a door opening and closing device is provided, which is installed on a box body 12 of an electrical apparatus and connected to a door body 13 of the electrical apparatus. The door opening and closing device drives the door body 13 to deflect the door body 13 relative to the box body 12, to enclose and open the box body 12, and thus a convenience of operation is improved. The door opening and closing device can also maintain the door body 13 at a current position after the door body 13 reaches a preset opening, to facilitate taking or storing items in the box body 12. Thus, a comfortability of use is improved, and a safety risk of collision to users caused by the door body deflecting and closing can also be avoided.

The door opening and closing device according to one or more embodiments of the disclosure is mainly used on an electrical apparatus to automatically open or close the door body 13. The door opening and closing device can automatically open the door body 13 after receiving a door opening signal. In some embodiments, the door opening signal may be triggered by a user or by the electrical apparatus itself. In some other embodiments, the door opening and closing device, after receiving a door closing signal, can automatically close the door body 13. The door closing signal may be triggered by a user or by the electrical apparatus itself.

In one or more embodiments of the disclosure, the door opening and closing device includes: a driving mechanism 100, a clutch 200, a linkage gear 300, a door rotation mechanism 400, and a door ejection mechanism 500. The driving mechanism 100 sequentially drives the clutch 200 and the linkage gear 300 to drive the door rotation mechanism 400 and the door ejection mechanism 500 to implement a door ejection operation and door rotation operation, and thus a door opening and closing process may be implemented. In some embodiments, the clutch 200 can selectively disconnect or connect a transmission structure between the driving mechanism 100 and the linkage gear 300, to implement a transmission control between the driving mechanism 100 and an implementation mechanism for door opening and closing that is formed by downstream linkage gear 300, door rotation mechanism 400 and door-lifting mechanism 500, and thus a switching between an automatic door-opening-closing operation and a manual door-opening-closing operation can be implemented. It can ameliorate a problem of mutual interference between the manual door-opening-closing operation and the door opening and closing device, and enhance a conveniences, smoothness and safety of use.

In some embodiments, a base 900 may be provided as a bearing body of the door opening and closing device, for respectively carrying and accommodating the above-mentioned various functional components. Thus, the base 900 and the above-mentioned various functional components can be mounted as a whole on an electrical apparatus such as single-door and double-door refrigerators, and have a good expansion and compatibility performance. It is worth noting that the base 900 may be configured with an upper cover or other housing structure with a covering constraint function to protect the above-mentioned functional components therein.

In an embodiment, the driving mechanism 100 and the clutch 200 may be fixed on the base 900. The linkage gear 300, as a transmission assembly jointing upstream and downstream assemblies, is rotatably disposed on the base 900. The linkage gear 300, through the clutch 200, is established with the driving mechanism 100 a transmission connection relationship that can be controlled as connected or disconnected. According to a set regulation mode, a transmission connection state of the linkage gear 300 and the driving mechanism 100 can be flexibly disconnected and maintained.

The door ejection mechanism 500 is connected to the linkage gear 300, and thus in a condition that the linkage gear 300 rotates, the door ejection mechanism 500 can be driven to act, to eject and push the door body 13 or reset the door body 13. The door body 13 is ejected and pushed by the door ejection mechanism 500, and thus the door ejection mechanism 500 can directly act on the door body 13, to break through door-opening resistance forces such as an adsorption force and the like between the door body 13 and the box body 12, to reduce a door-opening difficulty. After the door ejection mechanism 500 ejects the door body 13 open by a certain angle relative to the box body 12, the door rotation mechanism 400 continues to rotate the door body 13, to rotate and open the door body 13 by a larger opening, to be convenient for storing and taking materials.

The door rotation mechanism 400 is connected to the linkage gear 300 and is movably connected to the door body 13, and thus when the linkage gear 300 rotates, the door rotation mechanism 400 acts along with the linkage gear 300 to rotate the door body 13, to implement the door-opening-closing operation.

In some embodiments, actions of the door ejection mechanism 500 and the door rotation mechanism 400 can be designed to be coordinated in timing by arranging driving positions and modes. During a door opening process, the driving mechanism 100 establishes and maintains a transmission connection relationship with the linkage gear 300 through the clutch 200, to drive the linkage gear 300 to rotate forward. The door body 13 is first ejected and opened through the door ejection mechanism 500 by a certain angle, and then the door body 13 is relayed by the door rotation mechanism 400 to continue to be rotated to a position with a preset opening. A door opening mode that a door ejection with a large force and small angle is relayed with a door rotation with a small force and large angle can be formed, to be capable of improving a door-opening convenience while reducing a door-opening difficulty. During a door closing process, the linkage gear 300 rotates reversely. The door body 13 is driven by the door rotation mechanism 400 to rotate to gradually reduce a distance between the door body 13 and the box body 12 until the door body 13 is closed on the box body 12. During this period, the door ejection mechanism 500 is reset under a driving of the linkage gear 300 to be prepared for a next door opening operation.

In other words, action timings refer to that the door body 13 is, first through the door ejection mechanism 500 with a greater force, ejected and opened by a smaller angle, and then through the door rotation mechanism 400, driven to rotate by a larger angle. With the above-mentioned design for the action timings, the door-opening difficulty can be reduced, and the door-opening convenience can be improved. At the same time, requirements for overall structural strength and local area strength of the door rotation mechanism 400 can be reduced to a certain extent. With the above-mentioned design for the action timings, a structural stability of the door rotation mechanism 400 can be effectively protected, and the door rotation mechanism 400 can be avoided from being affected by a large reaction force when the door-opening resistance forces are broken through only by the door rotation mechanism 400, to ensure a stability of overall structure and a stability of function through a reasonable design for the action timings.

It is worth noting that the door rotation mechanism 400 and the door ejection mechanism 500 may not be configured with a sequential action timings.

On the other hand, the clutch 200 can flexibly establish or disconnect the transmission connection relationship between the driving mechanism 100 and the linkage gear 300, and thus the transmission connection relationship can be disconnected immediately after the door body 13 is opened in place. Therefore, the door body 13, during a subsequent rotation for opening and closing, will not interfere with the driving mechanism 100, to enable the manual door-opening-closing operation to be implemented conveniently. Similarly, the transmission connection relationship can also be disconnected immediately after the door body 13 is closed in place, to facilitate an implementation of the manual door-opening-closing operation.

In summary, in one or more embodiments of the disclosure, the driving mechanism 100, via the clutch 200 and the linkage gear 300, drives the door ejection mechanism 500 and the door rotation mechanism 400, to realize that the door ejection mechanism 500 and the door rotation mechanism 400 are driven simultaneously by a same driving mechanism 100, to simplify overall structural scale of the door opening and closing device. A transmission connection between the linkage gear 300 and the driving mechanism 100 can be controlled to be connected or disconnected by controlling actions of the clutch 200, to be capable of reducing an interference between the manual door-opening-closing operation and the driving mechanism 100. Thus, a risk of damaging the door opening and closing device can be reduced, to ensure a structural stability and reliability of the door opening and closing device. Through a functional division and coordination of the door ejection mechanism 500 and the door rotation mechanism 400, the door opening mode that a door ejection with a large force and small angle is relayed with a door rotation with a small force and a large angle can be formed, to be capable of reducing the door-opening difficulty to a certain extent. A convenience and comfortability of a door-opening-closing operation can be ensured while a structural stability of the door opening and closing device can be improved.

The above various functional structures will be described in detail below.

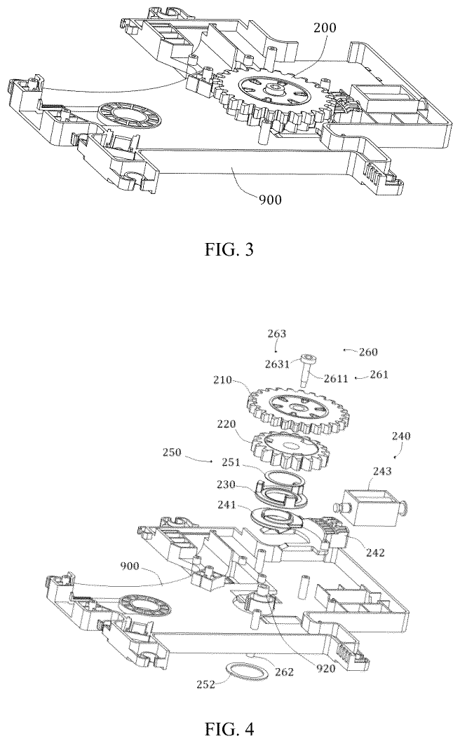

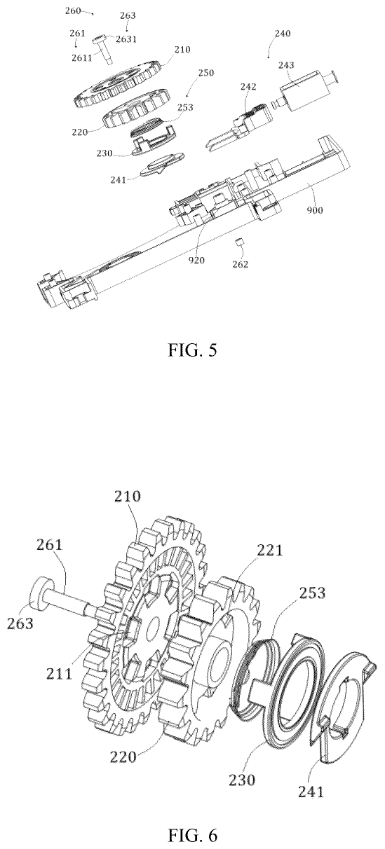

As shown in FIG. 3, FIG. 4, FIG. 5 and FIG. 6, in some embodiments, the clutch 200 may include a first transmission assembly 210 and a second transmission assembly 220 which are separably connected for respectively connecting the driving mechanism 100 and the implementation mechanism for door opening and closing of the door opening and closing device. The implementation mechanism for door opening and closing includes the linkage gear 300, and the door ejection mechanism 500 and the door rotation mechanism 400 which are connected to the linkage gear 300.

An engagement and separation of the driving mechanism 100 and the linkage gear 300 are achieved through an engagement and separation of the first transmission assembly 210 and the second transmission assembly 220, to control a connection state and separation state between the driving mechanism 100 and the door body 13. With an action of the clutch 20, a risk of interference between a manual operation of the door body 13 and an automatic opening and closing operation of the door body through the driving mechanism 100 can be reduced, to improve a convenience and safety of operation.

In order to achieve a separable connection between the first transmission assembly 210 and the second transmission assembly 220, the clutch 200 may further include a transmission connection assembly 230 and a clutch-ejection-push assembly 240 that cooperate with each other. In some embodiments, the transmission connection assembly 230 may be connected to the second transmission assembly 220. The transmission connection assembly 230 is pushed by the clutch-ejection-push assembly 240 to separate or connect the transmission connection assembly 230 from or to the first transmission assembly 210, to implement a connection and separation of the first transmission assembly 210 and the second transmission assembly 220.

The transmission connection assembly 230 itself, serving as a connecting component between the first transmission assembly 210 and the second transmission assembly 220, can move relative to the first transmission assembly 210. By pushing and ejecting the transmission connection assembly 230 to move, a connection relationship between the transmission connection assembly 230 and the first transmission assembly 210 is established or released, to implement a connection and separation of the first transmission assembly 210 and the second transmission assembly 220. The clutch-ejection-push assembly 240 is used to implement a push-ejection operation on the transmission connection assembly 230.

As shown in FIG. 4, FIG. 5 and FIG. 12, in some embodiments, the clutch-ejection-push assembly 240 may include an ejection-push sleeve 241 and a push rod 242. The ejection-push sleeve 241 is connected onto the transmission connection assembly 230. The push rod 242 is used to push the ejection-push sleeve 241, to be capable of pushing the transmission connection assembly 230, to enable the transmission connection assembly 230 to smoothly implement connection and disconnection operations with the first transmission assembly 210.

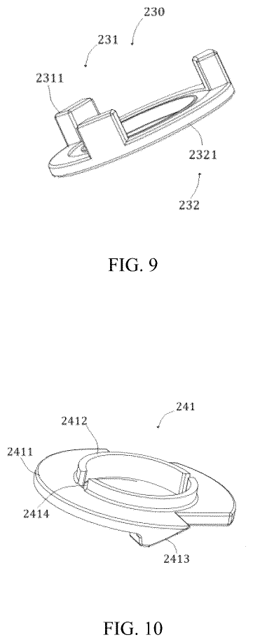

As shown in FIG. 9, in some embodiments, the transmission connection assembly 230 may include a connecting end 231 and an ejection-push end 232. The ejection-push end 232 is connected to the ejection-push sleeve 241. The transmission connection assembly 230 is pushed by the ejection-push sleeve 241 to move. The connecting end 231 can be separably connected on the first transmission assembly 210, and thus the first transmission assembly 210 and the second transmission assembly 220 can be connected as a whole or can be disconnected.

In some embodiments, the transmission connection assembly 230 and the second transmission assembly 220 can be integrally disposed, or the transmission connection assembly 230 can be fixed on the second transmission assembly 220. The transmission connection assembly 230 and the second transmission assembly 220 move as a whole to achieve a separation from or connection to the first transmission assembly 210. Thus, a molding, a processing and assembly operations of assemblies can be simplified.

In some embodiments, the connecting end 231 may be movably disposed on the second transmission assembly 220, to enable the connecting end 231 to move relative to the first transmission assembly 210 and the second transmission assembly 220 at the same time. Thus, the first transmission assembly 210 and the second transmission assembly 220 are in relative stable positions and postures, and thus a movement in a direction which is not for transmission operations is not generated as much as possible. It is convenient for maintaining a stable connection with upstream and downstream components, to maintain a stability of working state.

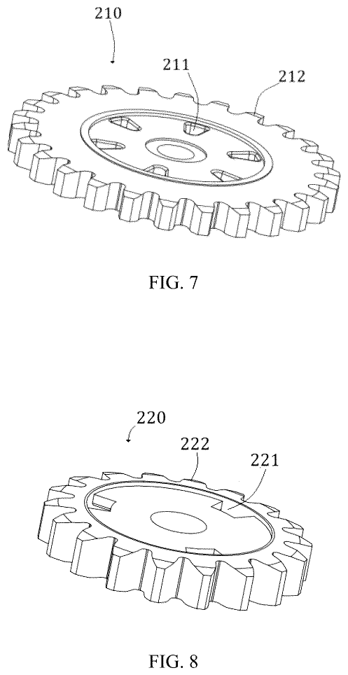

As shown in FIG. 6 and FIG. 7, in some embodiments, an engaging groove 211 may be formed on the first transmission assembly 210. The engaging groove 211 can be adapted to, and be snapped and embedded with the connecting end 231. Thus, a disengagement operation of the connecting end 231 from the engaging groove 211 can be smoothly implemented, to ensure a stability and reliability of a clutch operation.

As shown in FIG. 7, in some embodiments, the first transmission assembly 210 may be configured as a first transmission gear 212 to transmit a driving force through a way of gear meshing transmission. As a working mode of a gear rotating around its axis is taken into account, the engaging groove 211 may be disposed on an axial end face of the first transmission gear 212 to facilitate establishing and releasing a connection state between the connecting end 231 and the first transmission gear 212. An impact on working states of rotation and tooth meshing of the first transmission gear 212 can also be reduced.

It is worth noting that, in order to cooperate with a working posture of the first transmission gear 212, a way of movement of the second transmission assembly 220 may also be configured to be similar to a way that the first transmission gear 212 rotates around an axis, to achieve a synchronous rotation transmission.

As shown in FIG. 8, in some embodiments, the second transmission assembly 220 may be configured as a second transmission gear 222. The first transmission gear 212 and the second transmission gear 222 may be configured to be a coaxially rotating structure. The connecting end 231 is disposed on the second transmission gear 222. The connecting end 231 can be connected to the first transmission gear 212 by pushing the ejection-push end 232, and thus the first transmission gear 212 and the second transmission gear 222 are connected and rotate synchronously, to establish a connected transmission path for the driving force.

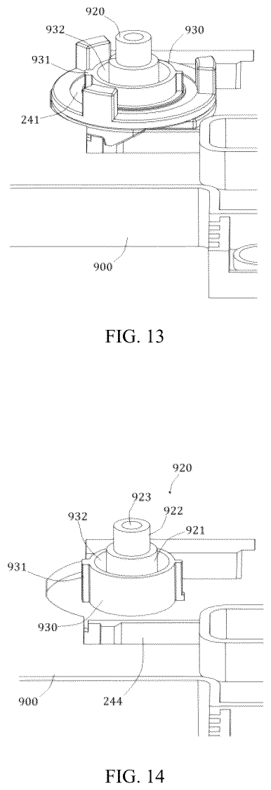

As shown in FIG. 4, FIG. 5, FIG. 13 and FIG. 14, in some embodiments, in order to achieve a rotation of the first transmission gear 212 and the second transmission gear 222, a rotating shaft structure may be disposed on the base 900 to guide an assembly and rotation of the first transmission gear 212 and the second transmission gear 222. In an embodiment, a common rotating shaft 920 may be disposed on the base 900. The first transmission gear 212 and the second transmission gear 222 may be sleeved on the common rotating shaft 920 along an axial direction to ensure a function stability of gear rotation.

In some embodiments, the common rotating shaft 920 may be configured as a variable-section shaft. A support column 921 and a rotating shaft column 922 are disposed in sequence from the base 900 upwardly. A diameter of the support column 921 is larger than a hole diameter of a shaft hole formed on the second transmission gear 222. A diameter of the rotating shaft column 922 can be adapted to the diameter of the shaft hole of the second transmission gear 222. Thus the second transmission gear 222 can be placed on the support column 921 and sleeved on the rotating shaft column 922, to make the second transmission gear 222 to be away from the base 900 by a certain height and to be rotated stably. The first transmission gear 212 can be stacked on the second transmission gear 222 and sleeved on the rotating shaft column 922 to be rotated.

In some embodiments, the connecting end 231 may be fixedly disposed on an axial end face of the second transmission gear 222. The second transmission gear 222 as a whole can be pushed toward or away from the first transmission gear 212 by pushing the ejection-push end 232, and thus the connecting end 231 is embedded with the engaging groove 211 or disengaged from the engaging groove 211. An overall operation is simple. A molding of structural members is relatively simple. An assembly operation is also simple and efficient.

As shown in FIG. 8, in some embodiments, an engaging hole 221 may be disposed on the second transmission gear 222, and the connecting end 231 can be movably embedded in the engaging hole 221, to push the ejection-push end 232. Thus, the connecting end 231 moves relative to the engaging hole 221 and approaches the first transmission gear 212, and in turn engages into the above-mentioned engaging hole 211 to establish a connection between the first transmission gear 212 and the second transmission gear 222.

In a process of the connecting end 231 being disengaged from the engaging groove 211 and also moving relative to the engaging hole 221, a movement operation of the transmission connection assembly 230 will have a lower impact on a position and posture of the first transmission gear 212 and the second transmission gear 222. It is convenient for maintaining a position and posture of rotation of the first transmission gear 212 and the second transmission gear 222, and helps to maintain a working state and operational reliability of the door opening and closing device.

In some embodiments, the engaging groove 211 may be configured as a through hole axially penetrating the first transmission gear 212, to be capable of preventing the connecting end 231 from directly pushing and ejecting a bottom of the engaging groove 211 to cause an unnecessary disturbance. Thus, a stability of rotation process of the first transmission gear 212 can be maintained.

In some embodiments, a working mode of rotation of the first transmission gear 212 and the second transmission gear 222 is considered, and in order to increase an efficiency of the connecting end 231 being engaged into the engaging groove 211, the connecting end 231 may be configured as connecting arms 2311. Accordingly, the number of the engaging grooves 211 may be the same as the number of the connecting arms 2311, or the number of the engaging grooves 211 may be more, to reduce a difficulty of the connecting arms 2311 being engaged into the engaging grooves 211.

It is worth noting that a rotation trajectory of the engaging groove 211 should be intersected with a movement trajectory of the connecting arm 2311, and thus the connecting arm 2311 can be embedded into the engaging groove 211.

In some embodiments, a distance from the connecting arm 2311 to an axis of rotating axle of the second transmission gear 222 should be consistent with a distance from the engaging groove 211 to an axis of rotating axle of the first transmission gear 212, and thus the engaging groove 211 and the connecting arm 2311 can be stably engaged and disengaged in an axial direction. Thus, an ejection-push force on the ejection-push end 231 is in a direction of the axis of rotating axle of the second transmission gear 222. The axis of rotating axle can be used as a reference during processing and assembly, to facilitate a disposing, assembly and ejection-push operation of the clutch-ejection-push assembly 240.

It is worth noting that a distance from the connecting arm 2311 to the axis of rotating axle of the second transmission gear 222 and the distance from the engaging groove 211 to the axis of rotating axle of the first transmission gear 212 may not be consistent. It is only required to ensure that a rotation trajectory of the engaging groove 211 should be intersected with the movement trajectory of the connecting arm 2311. When connecting arms 2311 and engaging grooves 211 are provided, an interval among the connecting arms 2311 and an interval among the engaging grooves 211 should be reasonably configured to avoid an inability of stable embedding.

In some embodiments, connecting arms 2311 may be arranged at an equal interval on a circular trajectory. Correspondingly, engaging grooves 211 may also be arranged at an equal interval on the circular trajectory, to be capable of forming a well-matched position and spacing arrangement pattern for an easy snapping-embedding.

It is worth mentioning that in order to increase an efficiency of matching and embedding between the connecting arm 2311 and the engaging groove 211, the number of the engaging grooves 211 may be appropriately increased. The number of the engaging grooves 211 may be set to be an integer multiple of the number of the connecting arms 2311, and thus in a condition that the engaging grooves 211 and the connecting arms 2311 are arranged at an equal interval, the efficiency of the adaptation and embedding between the connecting arms 2311 and the engaging grooves 211 can be greatly increased.

In some embodiments, the connecting arms 2311 may also be disposed on circular trajectories. Accordingly, a matched number of engaging grooves 211 should be provided on the first transmission gear 212 with reference to the circular trajectories to ensure a stable embedding.

In some embodiments, the ejection-push end 232 of the transmission connection assembly 230 is directly connected to the ejection-push sleeve 241. It is considered that an ejection-push direction is perpendicular to rotation directions of the second transmission gear 222 and the first transmission gear 212, the transmission connection assembly 230 can be configured to rotate around the rotating axle of the second transmission gear 222. The ejection-push end 232 is rotatably disposed on the ejection-push sleeve 241, and thus working states of a rotation movement and an axial movement of the transmission connection assembly 230 can be both considered.

In an embodiment, the ejection-push end 232 of the transmission connection assembly 230 may include an annular seat 2321, and the annular seat 2321 may be rotatably connected to the ejection-push sleeve 241, to achieve working states of rotation and axial movement of the transmission connection assembly 230. On the other hand, the ejection-push sleeve 241 only needs to axially eject and push the annular seat 2321 without considering a rotation state of the annular seat 2321. Thus, a structural setting and an installation configuration of the clutch-ejection-push assembly 240 can be greatly simplified.

It is worth mentioning that in order to reduce an interference of a movement operation of the transmission connection assembly 230 on the first transmission gear 212 and the second transmission gear 222, the annular seat 2321 may be disposed on a side of the second transmission gear 222 away from the first transmission gear 212. The connecting arm 2311 axially passes through the second transmission gear 222 and can be further moved and engaged into the engaging groove 211. Thus an operation of ejecting and pushing the annular seat 2321 will not be extended to be between two transmission gears, to be capable of maintaining a relative stability of the two transmission gears.

As shown in FIG. 10, in some embodiments, as the ejection-push sleeve 241 serves as a medium for ejecting and pushing, a shaft sleeve portion 2412 and a push-ejection portion 2411 may be disposed on the ejection-push sleeve 241, and the annular seat 2321 may be sleeved on the shaft sleeve portion 2412 to keep the annular seat 2321 in a rotatable state. Accordingly, the push-ejection portion 2411 is used to receive a push-ejection force from the push rod 242, and thus the ejection-push sleeve 241 as a whole moves along a direction of the axis of rotating axle of the first transmission gear 212 to implement an ejection-push operation for the transmission connection assembly 230.

In some embodiments, a moving direction of the ejection-push sleeve 241 is the direction of the axis of rotating axle of the second transmission gear 222. For the convenience of description, the moving direction of the ejection-push sleeve 241 is defined as a first direction. In order to reduce an overall thickness of the door opening and closing device and reduce a difficulty of molding and assembly, the ejection-push sleeve 241 can be pushed with a variable direction. That is, a direction for pushing the push rod 242 is not the first direction, but is at a certain angle to the first direction, to reduce a requirement of space occupation in the first direction.

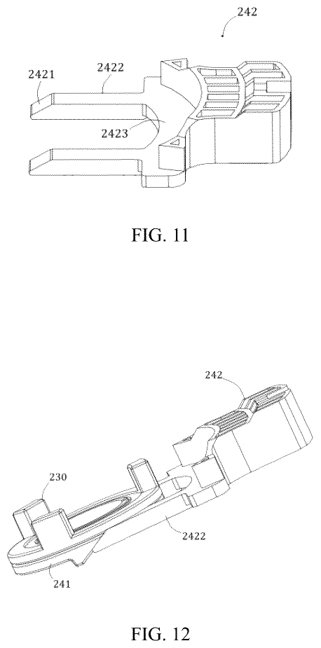

As shown in FIG. 10, FIG. 11 and FIG. 12, in an embodiment, a first ejection-push surface 2413 may be disposed on the push-ejection portion 2411, and a second ejection-push surface 2421 may be disposed on the push rod 242. The first ejection-push surface 2413 and the second ejection-push surface 2421 can contact each other and slide relative to each other. The first ejection-push surface 2413 is disposed at an acute angle relative to the first direction. The ejection-push sleeve 241 can be ejected and pushed along the first direction by ejecting and pushing the first ejection-push surface 2413, to push the transmission connection assembly 230 toward the first transmission gear 222.

In some embodiments, in order to optimize an efficiency of the ejection-push operations, an angle between the first ejection-push surface 2413 and the first direction may be set as ranging from 30 degrees to 60 degrees, for example, 30 degrees, 45 degrees or 60 degrees and so on.

In some embodiments, an angle between the ejection-push direction of the push rod 242 and the first direction may be controlled as 90 degrees, to minimize an arrangement space required for a cooperation relationship of the push rod 242 and the transmission connection assembly 230 and reduce an overall volume of the door opening and closing device.

As shown in FIG. 11 and FIG. 12, in some embodiments, in order to balance a force on the ejection-push sleeve 241, the number of the first ejection-push surfaces 2413 may be set to be two, and the push rod 242 is also correspondingly provided with two push arms 2422 to correspondingly eject and push two first ejection-push surfaces 2413, to ensure a uniformity of a force on the ejection-push sleeve by applying force at two points. The two push arms 2422 may be connected to a same connection portion 2423 to achieve a synchronous action and ensure a consistent magnitude of applied force, to ensure an evenly applied force on the ejection-push sleeve 241. Correspondingly, the two push arms 2422 are respectively provided with a second ejection-push surface 2421.

In some embodiments, two first ejection-push surfaces 2413 may be disposed on two opposite sides of the ejection-push sleeve 241. The two push arms 2422 may be disposed in parallel. The second ejection-push surface 2421 may be disposed on an end of the push arm 2422 away from the connection portion 2423, and thus the ejection-push operations can be achieved by ejecting and pushing the connection portion 2423.

In some embodiments, the numbers of the first ejection-push surface 2413, the second ejection-push surface 2421, and the push arm 2422 may be set to more than two according to specifications of the ejection-push sleeve 241.

As shown in FIG. 4 and FIG. 5, in order to implement the ejection-push operations of the push rod 242, a linear driver 243 may be connected to the push rod 242 to eject and push the push rod 242 in a second direction or reset the push rod 242, and thus the ejection-push sleeve 241 may be pushed to move in the first direction by the linear-driver. When the linear driver 243 is reset, the push rod 242 releases the ejection-push sleeve 241.

In some embodiments, the linear driver 243 may be a linear driving assembly such as an electromagnetic push rod or a ball screw.

In some embodiments, a driver may be configured as a reduction motor, or a motor equipped with a reduction gearbox, to be capable of properly controlling an output torque and rotation speed.

As shown in FIG. 14, in some embodiments, in order to reduce an impact vibration between the push rod 242 and the base 900, and an impact vibration between the base 900 and the ejection-push sleeve 241, shock-absorbing pads 244 may be disposed between the base 900 and the push rod 242, and between the ejection-push sleeve 241 and the base 900.

In some embodiments, the ejection-push sleeve 241, since subjected to a friction action along a circumferential direction of the annular seat 2321, has a certain tendency of circumferential rotation, and thus a cooperation of the ejection-push sleeve 241 with the clutch-ejection-push assembly 240 may be easily affected. An anti-rotation mechanism 930 may be disposed on the base 900, and snapped and embedded into the ejection-push sleeve 241 along the first direction to prevent a circumferential rotation of the ejection-push sleeve 241.

As shown in FIGS. 10, 14 and 15, in some embodiments, the anti-rotation mechanism 930 may include an anti-rotation rib 931. The anti-rotation rib 931 can slide relative to the ejection-push sleeve 241 in the first direction, to prevent both the circumferential rotation and a sliding in the first direction of the ejection-push sleeve 241. Generally speaking, an anti-rotation slot 2414 may be formed in the ejection-push sleeve 241. The anti-rotation slot 2414 can match the anti-rotation rib 931. The anti-rotation slot 2414 and the anti-rotation rib 931 can relatively slide along the first direction.

In some embodiments, the number of combined structures formed by the anti-rotation ribs 931 and the anti-rotation slots 2414 may be several. Intervals among anti-rotation ribs 931 may be set to be unequal, and thus an assembly position of the ejection-push sleeve 241 and the anti-rotation rib 931 is unique. Thus, a stable and reliable alignment of the first push surface 2413 and the second push surface 2421 during assembly can be ensured, to avoid an assembly misalignment and achieve an effective effect of mechanical anti-misalignment.

In some embodiments, a raised cylindrical member may be disposed on the base 900. The anti-rotation rib 931 may be disposed on an outer wall of the cylindrical member. The ejection-push sleeve 241 may be sleeved on the outside of the cylindrical member to achieve positioning and guiding. In an embodiment, the cylindrical member may be disposed coaxially with the common rotating shaft 920.

As shown in FIG. 4, FIG. 5 and FIG. 6, in some embodiments, in order to achieve an immediate and efficient response when a connection between the connecting end 231 and the first transmission assembly 210 is released, that is, to achieve an immediate and efficient disconnection between the connecting end 231 and the first transmission assembly 210, a separation assembly 250 may be provided to apply an action force to the transmission connection assembly 230 for disengaging from the first transmission assembly 210. After the push rod 242 is reset, a sufficient moving space is left, and the transmission connection assembly 230 is separated from the first transmission assembly 210 under an action of the separation assembly 250.

In some embodiments, the separation assembly 250 may be connected to the transmission connection assembly 230 and the second transmission assembly 220 respectively.

The connecting end 231 is caused, by pushing the ejection-push end 232 to move relative to the second transmission assembly 220, to be disconnected from the first transmission assembly 210.

In order to improve a response time, the separation assembly 250 may be configured as an elastic reset member 253 to continuously apply an action force of disengaging the transmission connection assembly 230 from the first transmission assembly 210. During the push rod 242 pushes the ejection-push sleeve 241 and the transmission connection assembly 230 to be connected to the first transmission assembly 210 and maintain a connected state, the action force of the elastic reset member 253 still exists but is limited by a stronger force of mechanical movements of the push rod 242, the ejection-push sleeve 241 and the transmission connection assembly 210, and thus the action force for separating is offset. When a state in which the push rod 242 pushes the ejection-push sleeve 241 is changed, the ejection-push sleeve 241 is reset and moves backward, and the ejection-push sleeve 241 will gradually reduce the push-ejection force. The action force of the elastic reset member 253 will push and eject the connecting end 231 of the transmission connection assembly 230 to be disconnected from the first transmission assembly 210, to achieve a good response time.

In some embodiments, the elastic reset member 253 may be configured as a spring. The spring may be disposed between the ejection-push end 232 and the second transmission assembly 220 to continuously apply an elastic action force to disengage the transmission connection assembly 230 from the first transmission assembly 210.

In some embodiments, the separation assembly 250 may be connected to the second transmission assembly 220 and the base 900 respectively to guide the transmission connection assembly 230 to move relative to the base 900, and thus the connecting end 231 of the transmission connection assembly 230 is disengaged from a connection relationship with the first transmission assembly 210.

In some embodiments, the separation assembly 250 may be configured as a first separation member 251 and a second separation member 252 which have a magnetic action force. A magnetic adsorption action force and a magnetic repulsion action force of the first separation member 251 and the second separation member 252 can be used to move the transmission connection assembly 230 relative to the base 900 to disconnect a connection state between the transmission connection assembly 230 and the first transmission assembly 210.

One of the first separation member 251 and the second separation member 252 is disposed on the base 900, and another of the first separation member 251 and the second separation member 252 is disposed on the transmission connection assembly 230. The first separation member 251 and the second separation member 252 have magnetic action forces to each other, and thus the base 900 and the transmission connection assembly 230 are kept in a tendency to approach each other, to provide an action force for continuously separating the transmission connection assembly 230 from the first transmission assembly 210.

In an arrangement state shown in FIG. 4, that is, in a state that the first transmission assembly 210, the second transmission assembly 220, the transmission connection assembly 230, and the base 900 are stacked in sequence, the first separation member 251 and the second separation member 252 are respectively connected onto the transmission connection assembly 230 and the base 900. A continuous magnetic pulling force between the first separation member 251 and the second separation member 252 is maintained to pull the transmission connection assembly 230 toward the base 900.

In some other embodiments, one of the first separation member 251 and the second separation member 252 may be disposed on the transmission connection assembly 230, and another of the first separation member 251 and the second separation member 252 may be disposed on the first transmission assembly 210 or the second transmission assembly 220. The first separation member 251 and the second separation member 252 have magnetic repulsion action forces to each other. The magnetic repulsion action force is maintained to keep a tendency of the transmission connection assembly 230 moving away from the first transmission assembly 210 or the second transmission assembly 220, to provide an action force for continuously separating the transmission connection assembly 230 from the first transmission assembly 210.

In an arrangement state shown in FIG. 4, in a state that the first transmission assembly 210, the second transmission assembly 220, the transmission connection assembly 230 and the base 900 are stacked in sequence, one of the first separation member 251 and the second separation member 252 is disposed on the transmission connection assembly 230, and another of the first separation member 251 and the second separation member 252 is disposed on the first transmission assembly 210 or the second transmission assembly 220 or the upper cover which is located more outside. A continuous magnetic repulsion force between the first separation member 251 and the second separation member 252 is maintained to push the transmission connection assembly 230 toward the base 900.

In some embodiments, the first separation member 251 and the second separation member 252 may be configured as magnetically absorbed metal members and magnets, to form a continuous separating action force.

As shown in FIG. 4, FIG. 5, FIG. 6 and FIG. 14, in some embodiments, the first transmission gear 212 and the second transmission gear 222 may be stopped on the common rotating shaft 920 by the stop assembly 260, and be restricted from an axial disengagement from each other, to ensure a stability and reliability of transmission structure.

The stop assembly 260 may be configured as a connecting member 261 and a stop member 263. An end of the connecting member 261 is connected to the base 900, or is connected to a structure, such as the common rotating shaft 920, on a surface of the base 900. The first transmission assembly 210 and the second transmission assembly 220 are disposed on the connecting member 261. Then the stop member 263 is fixed to another end of the connecting member 261 to block the first transmission assembly 210 and the second transmission assembly 220 to prevent a disengagement of the first transmission assembly 210 or the second transmission assembly 220 from the connecting member 261, to ensure a stability of clutch transmission structure.

In some embodiments, the connecting member 261 and the stop member 263 may be integrated and configured into a bolt with head, with a bolt head serving as the stop member 263. In one embodiment, an independent stop member 263 may be provided and sleeved on a bolt rod, with a bolt head restricting a disengagement of the stop member 263.

In some embodiments, a fastening through hole 923 may be disposed at a top end of the common rotating shaft 920 along an axial direction of the common rotating shaft 920 for cooperating with a bolt with head to lock the first transmission assembly 210 and the second transmission assembly 220.

In some embodiments, a rod portion of the bolt with head may be configured as a smooth peripheral surface, and then an inner wall surface of the fastening through hole 923 may be configured as a smooth inner peripheral surface to achieve low friction matching between the rod portion and the inner wall surface, to avoid affecting transmission operations of the first transmission assembly 210 and the second transmission assembly 220. A lock member 262 may be disposed at another end of the fastening through hole to lock the bolt with head. The lock member 262 may be a latch or a nut.

In some embodiments, the connecting member 261 may be configured as a connecting shaft 2611. An end of the connecting shaft 2611 is fixed on the base 900. The first transmission assembly 210, the second transmission assembly 220 and the ejection-push sleeve 241 are sleeved on the connecting shaft 2611 to restrict a disengagement along a radial direction of the connecting shaft 2611. The stop member 263 may be configured as a baffle 2631. The baffle 2631 is fixedly disposed to another end of the connecting shaft 2611, to implement a limitation along an axial direction of the connecting shaft 2611 and stop the first transmission assembly 210, the second transmission assembly 220 and the ejection-push sleeve 241 from disengaging in the axial direction.

In some embodiments, the baffle 2631 may be integrally formed on the connecting shaft 2611.

In some embodiments, the baffle 2631 is detachably fixed to the connecting shaft 2611, such as by being snapped and embedded in a narrow neck groove at an end of the connecting shaft 2611 through an engaging hole or an engaging groove that is formed on the baffle 2631, or by in a similar to a snapping-embedding manner.

In some embodiments, a baffle 2631 may also be fixed onto the connecting shaft 2611 via a lock member such as a latch that is connected to an end head portion of the connecting shaft 2611.

When a clutch control is performed, the linear driver 243 is actuated to push the push rod 242 to move toward the ejection-push sleeve 241, and the second push surface 2421 at a head end of the push rod 242 ejects and pushes the first push surface 2413, and thus the ejection-push sleeve 241 moves along the first direction to push and eject the connecting end 231 to move toward the first transmission gear 212 until the connecting end 231 is embedded into the engaging groove 211, and thus the first transmission gear 212 and the second transmission gear 222 are connected as a whole. At this time, the linear driver 243 stays at the current position and supports the ejection-push sleeve 241 through the push rod 242 at the bottom 900, to support the transmission connection assembly 230, and thus the first transmission assembly 210 and the second transmission assembly 220 are maintained in a transmission connection state. When a disconnection is required, the linear driver 243 is reset, and the connecting end 231 of the transmission connection assembly 230 gradually disengages from the engaging groove 211 under an action of the separation assembly 250 until the first transmission gear 212 and the second transmission gear 222 are disconnected. Thus, the transmission path for the driving force is disconnected.

As shown in FIG. 1, in some embodiments, the driving mechanism 100 may include a driver 110 and an output gear 120. The output gear 120 is fixed on an output rotating shaft of the driver 110, and thus the output gear 120 can rotate around an axis of rotating shaft of the driver 110 under a drive of the driver 110 to output torque.

The output gear 120 meshes with the first transmission assembly 210, to drive the first transmission assembly 210 to rotate. The output gear 120 may be arranged side by side and meshed with the first transmission assembly 210. The driving mechanism 100 and the door rotation mechanism 400 may be further disposed on a same side of a line connecting the first transmission assembly 210 and the rotation center 438 of the linkage gear 300, to be capable of improving a compactness of arrangement to a certain extent.

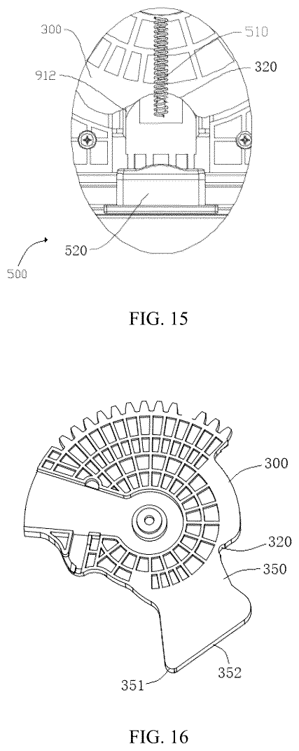

As shown in FIG. 15 and FIG. 18, in some embodiments, the door ejection mechanism 500 may include a door ejection member 520. The door ejection member 520 may be movably disposed on the base 900. The limit groove 320 on the linkage gear 300 is formed with a door ejection surface 322 therein. In a condition that a driving mechanism 100 drives the linkage gear 300 to rotate, the door ejection surface 322 can be rotated with the linkage gear 300, and push the door ejection member 520 to move relative to the base 900 to make the door ejection member eject the door body 13 open.

In some embodiments, in a condition that the door body 13 is closed, an end of the door ejection member 520 is located in the limit groove 320. In a condition that the linkage gear 300 is rotated, the linkage gear 300 pushes, through the door ejection surface 322, the door ejection member 520 to move relative to the base 900 to push the door body 13, and then drives the door rotation mechanism 400 to continue to rotate the door body 13.

In one or more embodiments of the disclosure, in order to improve a sealing effect between the door body 13 and the box body 12 when the door body 13 is closed on the box body 12, the door body 13 is usually pressed onto the box body 12 with a relatively large pressure, or the door body 13 is adsorbed onto the box body 12 through an adsorption structure. There is a larger adsorption force between the door body 13 and the box body 12, and thus a larger acting force is required for the door body 13 to be disengaged from the box body 12 when the door body 13 needs to be opened. In a condition that the linkage gear 300 is rotated, the door ejection surface 322 can push the door ejection member 520 to move relative to the box body 12, to eject the door body 13 open with a larger force. The door ejection surface 322 disposed on the linkage gear 300 directly acts on the door ejection member to directly eject the door body 13 open. That is, the linkage gear 300 can be driven by a driving mechanism 100 to rotate, to make the door ejection member 520 to eject the door body 13 open, and then the door rotation mechanism 400 opens the door body 13 to have an increased opening. Thus, the number of components of the entire door opening and closing device can be reduced, and an integration of the entire door opening and closing device can be improved. Stable direction and effect of ejecting-abutting force can be achieved.

In some embodiments, in a condition that the linkage gear 300 is rotated, the door ejection member 520 cannot rotate with the linkage gear 300, and the door ejection member 520 can move toward or away from the door body 13 under an action of the door ejection surface 322, to eject the door body 13 open. The door ejection member 520 can be attached to an outer surface of the door ejection surface 322. During the linkage gear 300 is rotated, the door ejection member 520 moves along a profile of the outer surface of the door ejection surface 322 and moves in a direction approaching or away from the door body 13 to eject the door body 13 open.

That is to say, in one or more embodiments of the disclosure, there is no direct connection relationship between the door ejection member and the door ejection surface 322. The door ejection member may be in contact with the door ejection surface 322, or may not be in contact with the door ejection surface 322. When a driving structure drives the linkage gear 300 to rotate, the door ejection member may be abutted against and held by the door ejection surface 322, and may be pushed by the door ejection surface 322 to move in a direction approaching the door body 13 to eject the door body 13 open.

In other words, in one or more embodiments of the disclosure, the door ejection surface 322 is rotated with the linkage gear 300, while the door ejection member 520 performs a linear motion, and thus the stable direction and effect of ejecting-abutting force can be achieved.

For the convenience of description, a rotation direction of the linkage gear 300 that can open the door body 13 is defined as rotating forward. If the door opening and closing device receives a door opening signal, a driving structure drives the linkage gear 300 to rotate forward, and the door rotation mechanism 400 can follow the linkage gear 300 to rotate forward, to open the door body 13. If the door opening and closing device receives a door closing signal, the driving structure drives the linkage gear 300 to rotate reversely, and the door rotation mechanism 400 can be rotated reversely with the linkage gear 300, to close the door body 13.

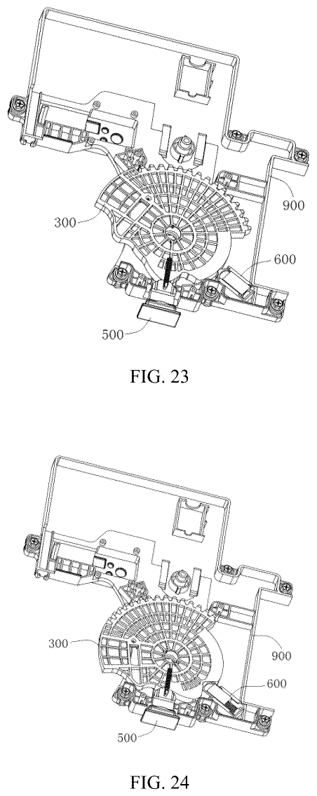

As shown in FIG. 15, FIG. 18, FIG. 22, FIG. 23 and FIG. 24, in some embodiments, in a condition that the door ejection surface 322 is rotated with the linkage gear 300, the door ejection surface 322 abuts against and holds the door ejection member 520, and can push the door ejection member 520 to move relative to the base 900, to make the door ejection member 520 eject the door body 13 open.

The door ejection surface 322 may be disposed at a side of the limit groove 320 and opposite to a transition surface 328. During the door ejection surface 322 is rotated with the linkage gear 300, the door ejection surface 322 abuts against and holds the door ejection member 520, to make the door ejection member 520 move in a direction approaching the door body 13, and the door ejection member 520 gradually extends out of the box body 12. As the linkage gear 300 is rotated, the door ejection member 520 extends more and more out of the box body 12, to gradually eject the door body 13 open.

In some embodiments, the door ejection surface 322 is protruded on the linkage gear 300, and thus distances from a rotation center of the linkage gear 300 to various locations on the door ejection surface 322 are different. Since the distances from the rotation center 438 of the linkage gear 300 to various locations on the door ejection surface 322 are different, during a rotation of the linkage gear 300, the door ejection surface 322 abuts against and holds the door ejection member 520 to move in a direction approaching the door body 13, to make the door ejection member gradually eject the door body 13 open.

In some embodiments, the door ejection surface 322 is gradually extended in a direction away from the rotation center 438 of the linkage gear 300. It can be understood that the door ejection surface 322 is inclined, and when the door body 13 is closed on the box body 12, the door ejection member 520 is disposed in the limit groove 320 and located at a jointing portion of the door ejection surface 322 and the peripheral surface of the linkage gear 300, and is closest to the rotation center 438 of the linkage gear 300. Since the door ejection surface 322 is protruded and inclined in a direction away from the rotation center 320 of the linkage gear 300, when the linkage gear 300 is driven by a driving structure to rotate, the door ejection surface 322 will abut against and hold the door ejection member 520 to move in a direction approaching the door body 13, to make the door ejection member 520 gradually extend out of the box body 12, to eject the door body 13 open.

It is easily understood that an angle by which the door member 520 can open the door body 13 is related to a distance between the door ejection surface 322 and the rotation center 438 of the linkage gear 300. For the convenience of description, a point on the door ejection surface 322 which is farthest from the rotation center 438 of the linkage gear 300 is defined as the connection point 326. If the distance between the connection point 326 and the rotation center 438 of the linkage gear 300 is farther, an extending length of the door ejection member 520 is longer, and the angle by which the door body 13 to be opened is larger.

In some embodiments, the door ejection member 520 can eject the door body 13 open by an angle of 3 degrees to 5 degrees. The angle can be flexibly set according to an angle required to break through a door-opening resistance force of the door body 13.

In some embodiments, during a process in which the door body 13 is ejected open through the door ejection surface 322, the door body 13 may have been ejected open through a middle portion of the door ejection surface 322, and thus the door body 13 can be opened by a smaller angle to facilitate the door rotation mechanism 400 to continue opening the door body 13 during a continuous rotation of the linkage gear 300.

As shown in FIG. 18 and FIG. 24, in some embodiments, the peripheral surface of the linkage gear 300 further includes an avoidance surface 324. The avoidance surface 324 is connected to the door ejection surface 322. After the door ejection member is disengaged from abutting and holding with the door ejection surface 322, the elastic reset member 510 can be reset and follow the avoidance surface 324.

In a direction of forward rotation of the linkage gear 300, the door ejection surface 322 is disposed in front of the avoidance surface 324, that is, in a process of rotation of the linkage gear 300, the door ejection surface 322 first contacts the door ejection member 520, to eject and abut against the door ejection member 520 to move in a direction approaching the door body 13. After the door ejection member 520 is disengaged from ejecting and abutting with the door ejection surface 322, the door ejection member 520 contacts the avoidance surface 324, to enable the door ejection member 520 to move in a direction away from the door body 13. Thus, the door ejection member 520 after ejecting the door body 13 open, can be retracted onto the box body 12 to facilitate subsequent door closing.

It is easily understood that if the linkage gear 300 is not provided with the avoidance surface 324 thereon, after the door ejection member 520 ejects the door body 13 open, the door ejection member 520 always extends out of the box body 12. When the door body 13 needs to be closed, the door ejection member 520 is located outside the box body 12 and will interfere with the door body 13, and thus the door body 13 cannot be closed. Therefore, a main purpose of providing the avoidance surface 324 is to provide the door ejection member 520 with a space to be retracted onto the box body 12 after the door ejection member 520 ejects the door body 13 open. Thus, the door ejection member 520 can be retracted onto the box body 12 after the door ejection member 520 ejects the door body 13 open, to avoid the door body 13 from being unable to be retracted.

After the door ejection surface 322 ejects and abuts against the door ejection member to an outside of the box body 12 and when the avoidance surface 324 is rotated to a rear of the door ejection member 520, the door ejection member 520 cannot automatically return to an original position and cannot automatically follow the avoidance surface 324 to be retracted onto the box body 12. An elastic member 510 may be disposed on the base 900 and the door ejection Substitute clean member 520. The door ejection member 520 can be retracted onto the box body 12 through a restoring force of the elastic member 510.

As shown in FIG. 18 and FIG. 23, that is, in a process of the door ejection surface 322 ejecting and abutting against the door ejection member 520, the elastic member 510 is gradually deformed. When the connection point 326 contacts the door ejection member 520, a deformation of the elastic member 510 reaches the maximum. In a process of the driving structure driving the linkage gear 300 to continue to be rotated, the door ejection member 520 is disengaged from abutting and holding with the door ejection surface 322. After the disengagement, the avoidance surface 324 provides a space for the door ejection member to be retracted onto the box body 12. The door ejection member 520, under an action of the restoring force of the elastic member 510, moves in the direction away from the door body 13, to enable the entire door ejection member 520 to be retracted onto the box body 12, to facilitate a closing of the door body 13.

In some embodiments, the elastic member 510 may be a spring or a torsion spring, either one of which may be selected.

In a condition that the elastic member 510 is a spring, an end of the spring is connected to the door ejection member 520, and another end of the spring may be fixed on the base 900 or may be fixed on the connecting shaft 2611 of the linkage gear 300. In some embodiments, a rotating shaft is fixedly connected to the base 900. That is to say, an end of the spring away from the door ejection member is required to be connected to a fixed structure.

If the elastic reset member 510 is a spring, the spring is gradually stretched during the process of the door ejection surface 322 ejecting and abutting against the door ejection member. The spring reaches a maximum stretched amount when the connection point 326 contacts the door ejection member 520. In a process of the driving structure driving the linkage gear 300 to continue to rotate, the door ejection member 520 is disengaged from abutting and holding with the door ejection surface 322. After the disengagement, the avoidance surface 324 provides a space for the door ejection member 520 to be retracted onto the box body 12. The door ejection member 520, under an action of the restoring force of the spring, moves in the direction away from the door body 13, to enable the entire door ejection member 520 to be retracted onto the box body 12, to facilitate a closing of the door body 13.

If the elastic member 510 is a torsion spring, a middle portion of the torsion spring and a first end of the torsion spring are disposed on the base 900, and a second end of the torsion spring is connected to the door ejection member 520. In some embodiments, the middle portion of the torsion spring is connected to the first end and the second end respectively. When the door ejection member 520 ejects the door body 13 open, the door ejection member needs to overcome a torsion force of the torsion spring.

If the elastic member 510 is a torsion spring and in a condition that the door ejection member is ejected and abutted against by the door ejection surface 322 to move in a direction approaching the door body 13, the torsion spring is twisted. After the door ejection member 520 is disengaged from abutting and holding with the door ejection surface 322, the door ejection member 520, under the action of the restoring force of the torsion spring, can follow the avoidance surface 324 to move in the direction away from the door body 13, to enable the door ejection member 520 to be reset to avoid an interference of the door ejection member 520 and the door body 13, and to facilitate a door closing.

In some embodiments, the door ejection surface 322 and the avoidance surface 324 are connected at the connection point 326. A distance between the connection point 326 and the rotation center 438 of the linkage gear 300 is greater than a distance from any point on the avoidance surface 324 and the door ejection surface 312 to the rotation center 438 of the linkage gear 300.

In some embodiments, the door ejection surface 322 and the avoidance surface 324 are connected to each other. A point where the door ejection surface 322 and the avoidance surface 324 are connected can be defined as the connection point 326. The connection point 326 is a point on the door ejection surface 312 and the avoidance surface 324 that is farthest from the rotation center 438 of the linkage gear 300. In a condition that the connection point 326 ejects and abuts against the door ejection member 520, the door ejection member 520 ejects the door body 13 to open by a maximum angle. When the avoidance surface 324 is rotated to a rear of the door ejection member 520, the avoidance surface 314 provides the door ejection member 520 with a space for moving away from the door body 13, to enable the door ejection member 520 to be retracted onto the box body 12, to be convenient for subsequent door closing.

It is easily understood that, in a process of the door ejection surface 322 ejecting and abutting against the door ejection member 520, the door body 13 is gradually opened. It is not that the door body 13 is opened by the door ejection member only at a time when the connection point 326 is in contact with the door ejection member 520. In a process of the door ejection surface 322 rotating with the linkage gear 300, it is possible that when one of points on the door ejection surface 322 ejects and abuts against the door ejection member, the door ejection member 520 ejects the door body 13 open. It is only when the connection point 326 ejects and abuts against the door ejection member 520, the door body 13 in a door ejection stage reaches the maximum opening.

A speed of ejecting door of the door ejection member 520 is related to a rotation speed of the linkage gear 300 which is driven by the driving structure. The faster the linkage gear 300 is rotated, the faster the door ejection member 520 ejects the door body 13 open. If the rotation speed of the linkage gear 300 is slower, the speed at which the door ejection member 520 ejects the door body 13 open will be slower.

In some embodiments, the avoidance surface 324 and the door ejection surface 322 may be cambered surfaces or inclined planes.

It should be noted that, in some embodiments, an end of the door rotation mechanism 400 is connected to the linkage gear 300, and another end of the door rotation mechanism 400 is connected to the door body 13. The door ejection member 520 and the door rotation mechanism 400 can be driven by a same driving structure and linkage gear 300 to realize functions of door ejection and door opening. The door ejection member 520 first ejects the door body 13 open by a smaller angle, and the door rotation mechanism 400 then further opens the door body 13.

As shown in FIG. 15, in some embodiment, a mounting groove 912 is disposed on the base 900. The door ejection member 520 is movably disposed in a mounting groove 912. The mounting groove 912 is in a shape of an elongated strip. Since the door ejection member 520 is disposed in the mounting groove 912, the door ejection member 520 can move along an extending direction of the mounting groove 912, to enable the door ejection member 520 to move closer to or away from the door body 13.

The extending direction of the mounting groove 912 may be from the linkage gear 300 to the door body 13. In order to reduce a loss of a door ejection force when the door ejection member 520 is ejecting the door, the mounting groove 912 may be perpendicular to the door body 13 when the door body 13 is closed.

In some embodiments, the door ejection surface 322 and the linkage gear 300 are integrally formed. The door ejection surface 322 and the linkage gear 300 are integrally formed, it is equivalent to the linkage gear 300 directly interacting with the door ejection member 520, to be capable of reducing the number of other components and reducing structures of the door opening and closing device 11 to decrease an occupied space.

The linkage gear 300 is driven by the driving structure to rotate. The rotation of the linkage gear 300 can be converted into a movement of the door ejection member 520 by providing the door ejection surface 322. A door ejection can be implemented by providing the linkage gear 300 before a door opening, and thus an application range of the linkage gear 300 is increased, a driving structure for the door ejection member 520 is reduced. Thus, structures of the door opening and closing device 11 are decreased and the occupied space is reduced.

In conclusion, the door opening and closing device 11 is provided according to some embodiments of the disclosure. In order to improve a sealing effect between the door body 13 and the box body 12 when the door body 13 is closed on the box body 12, the door body 13 is usually pressed onto the box body 12 with a relatively large pressure, or the door body 13 is adsorbed onto the box body 12 through an adsorption structure. There is a larger adsorption force between the door body 13 and the box body 12, and thus a larger acting force is required for the door body 13 to be disengaged from the box body 12 when the door body 13 is opened. A door ejection surface 322 is disposed on the linkage gear 300. In a condition that the linkage gear 300 is rotated, the door ejection surface 322 can push the door ejection member to move relative to the box body 12, to eject the door body 13 open. The door ejection surface 322 disposed on the linkage gear 300 directly acts on the door ejection member 520 to directly eject the door body 13 open. That is, the linkage gear 300 can be driven by a driving structure to rotate, to make the door ejection member 520 eject the door body 13 open. Thus, the number of components of the entire door opening and closing device can be reduced, and an integration of the entire door opening and closing device can be improved.

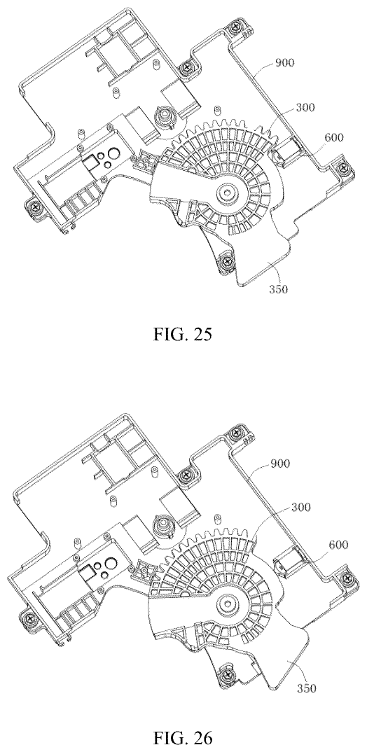

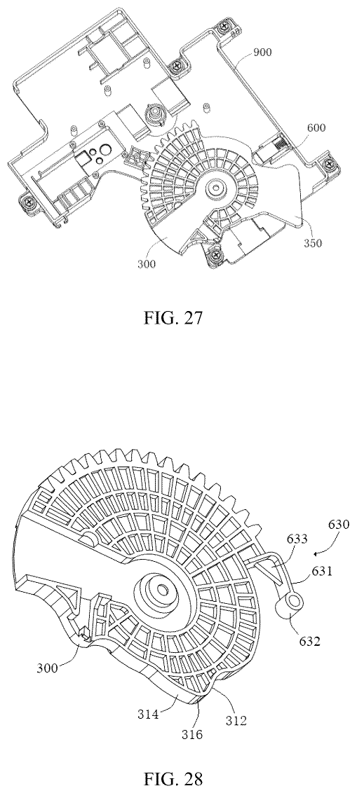

As shown in FIG. 16, FIG. 25, FIG. 26 and FIG. 27, in some embodiments, the door ejection mechanism 500 may also be configured as a door ejection portion 350 which is disposed on and protruded from the linkage gear 300. In a condition that the linkage gear 300 rotates, the door ejection portion 350 extends out of the base 900 to directly break through door-opening resistance forces such as an adsorption force of the door body 13 and the like to eject the door body 13 open. Thus, the door rotation mechanism 400 is facilitated to rotate the door body 13, to reduce a door-opening difficulty to a certain extent.

It is worth explaining that the door ejection portion 350 ejects the door body 13 open indicates that when the door body 13 encloses the box body 12, that is, in a condition that the door body 13 is adsorbed on the box body 12, the door ejection portion 350 rotates with the linkage gear 300. During a rotation of the door ejection portion 350, the door ejection portion 350 gradually acts on the door body 13, to cause the door body 13 and the box body 12 to be disengaged from an adsorption, to eject the door body 13 open.

In some embodiments, the door ejection portion 350 has a door ejection point 351. In a condition that the driving mechanism drives the linkage gear 300 to rotate, the door ejection point 351 abuts against and holds the door body 13 to eject the door body 13 open.

During the driving mechanism drives the linkage gear 300 to rotate, the door ejection portion 350 gradually contacts the door body 13. In a condition that the driving mechanism continues to drive the linkage gear 300 to rotate, the door ejection portion 350 extends out of the box body 12, to cause the door ejection point 351 to eject the door body 13 open.

In some embodiments, the door ejection point 351 is a point on the door ejection portion 350 that is farthest from a rotation center of the linkage gear 300. During the driving mechanism drives the linkage gear 300 to rotate, the door ejection portion 350 rotates with the linkage gear 300. The door ejection point 351 can eject the door body 13 to a farthest location where the door ejection portion 350 can eject and abut against the door body 13.

In some embodiments, the door ejection portion 350 has an appearance surface 352, and the door ejection point 351 is disposed at an end of the appearance surface 352.

The appearance surface 352 may be a plane. The door ejection point 351 is disposed at an end of the appearance surface 352. During the driving mechanism drives the linkage gear 300 to rotate, a portion of the appearance surface 352 rotates onto the box body 12, and another portion of the appearance surface 352 rotates outside the box body 12. The portion of the appearance surface 352 outside the box body 12 gradually ejects and abuts against the door body 13 until the door ejection point 351 abuts against and holds the door body 13 and ejects the door body 13 open.

It is easily understood that, as the appearance surface 352 rotates with the linkage gear 300, the portion of the appearance surface 352 extending outside the main body 12 gradually abuts against and holds the door body 13. During a rotation of the appearance surface 352, the portion of the exterior surface 352 extending out of the box body 12 becomes more and more, to increase an abutting-holding force with the door body 13, to enable the door body 13 to overcome the adsorption force between the door body 13 and the box body 12, to eject the door body 13 open.

When the door body 13 is closed, the exterior surface 352 is flush with an opening of the box body 12. During the driving mechanism drives the driving mechanism 300 to rotate, the door ejection point 351 can quickly rotate out of the box body 12, to enable the door ejection point 351 to quickly eject the door body 13 open.

In some embodiments, in a condition that the door body 13 is closed, the exterior surface 352 is flush with an opening of the box body 12, to ensure an aesthetic appearance when the door opening and closing device 11 is not activated.

When the door body 13 is rotated to a position with a preset opening, the linkage gear 300 will no longer drive the door rotation mechanism 400 to act, and a driving force will be stopped from applying to the linkage gear 300 to keep the door body 13 at a current position, that is, a driving relationship between the door body 13 and the upstream driving device is broken off, to avoid an interference with manual operation of the door body 13, and thus to facilitate a manual operation of the door body 13. However, a center of gravity of the door body is caused to be shifted due to items stored on the door body 13 of an electrical apparatus such as a refrigerator, or a tilted placement of the refrigerator, which can result in an autonomous deflection of the door body 13, and thus the door body 13 cannot maintain an opening. Thus, it is inconvenient to use and even causes a safety risk of collision to an operator.

As shown in FIG. 1, FIG. 2, FIG. 22, FIG. 23 and FIG. 24, in some embodiments, in order to solve a problem that the door body 13 cannot maintain an opening when the door opening and closing device is shut down, a limit groove 320 may be formed on the linkage gear 300, and a suspension mechanism 600 may be disposed on the base 900. When the linkage gear 300 is rotated to a position where the limit groove 320 is opposite to the suspension mechanism 600, the suspension mechanism 600 moves relative to the base 900 and then ejects and abuts against the limit groove 320, to lock the linkage gear 300 on the base 900, to prevent the door rotation mechanism 400 from rotating the door body 13, to achieve a suspension of the door body 13 and maintain a position with preset opening.

That is, with multiple functions of the limit groove 320 of the suspension mechanism, it can not only realize a suspension, braking and limiting, but also utilize shape characteristics of the limit groove 320 as a functional portion for ejecting and pushing the door ejection member 520 to simplify a structure of the linkage gear 300. Of course, an independent limit groove 320 may also be provided, and the embodiment of the disclosure is not limited thereto.

That is to say, the limit groove 320 is rotated with the linkage gear 300. The suspension mechanism 600 can move relative to the base 900, and can change a movement state of the suspension mechanism 600 in response to position changes of a rotating peripheral surface of the linkage gear 300. Thus, when the limit groove 320 is rotated to a position where the limit groove 320 matches and is opposite to the suspension device 600, the suspension device 600 can eject and abut against, and clamp the limit groove 320, to lock the linkage gear 300 and limit a rotation of the linkage gear 300, and thus the door rotation mechanism 400 can be braked to prevent the door body 13 from deflecting, to keep the door body 13 to be suspended at a preset position.

It is worth mentioning that a state of ejecting and abutting against for locking of the suspension mechanism 600 and the limit groove 320 is a reversible state. When an external driving force applied to the linkage gear 300 is greater than a braking force between the suspension mechanism 600 and the limit groove 320, the linkage gear 300 is enabled to break through an action of ejecting and abutting against for limiting, and thus the linkage gear 300 goes on to be rotated and to be released from a braking state, to be capable of driving the door rotation mechanism 400 to rotate the door body 13 to be closed, or further expanding an opening of the door body 13.

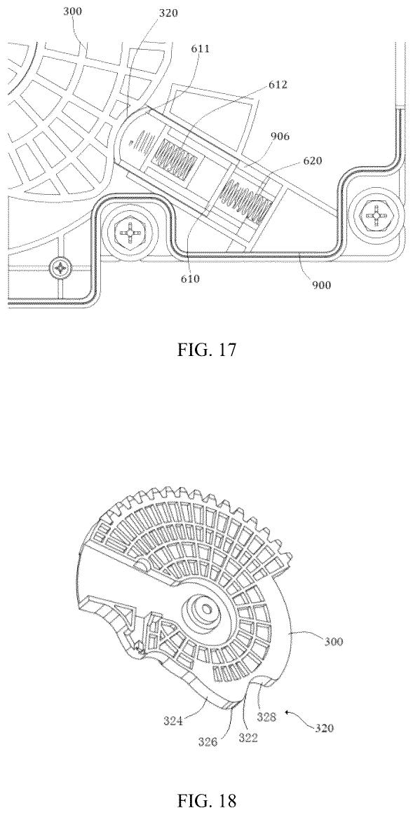

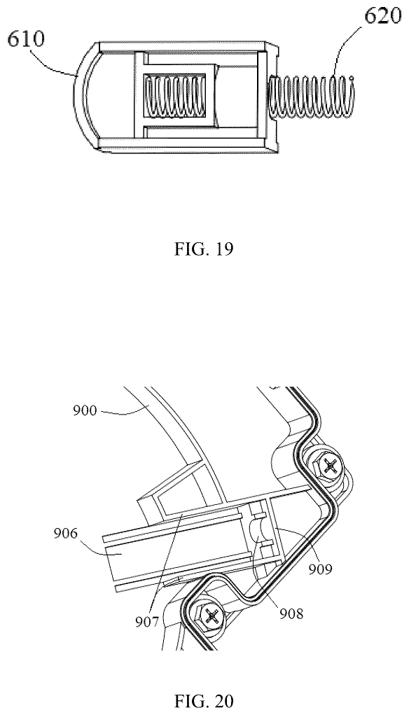

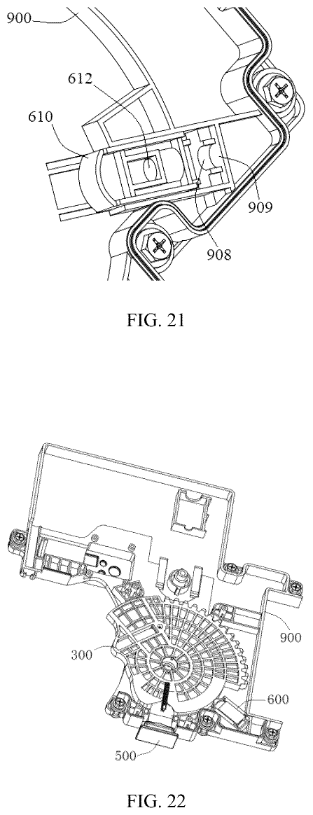

As shown in FIG. 17, FIG. 18, FIG. 19, FIG. 20 and FIG. 21, the suspension mechanism 600 may include a suspension member 610 and an ejection-push member 620. The suspension member 610 is movably disposed on the base 900, and continuously ejects and abuts against the linkage gear 300, and can match, eject and abut against, and clamp the limit groove 320. When the linkage gear 300 makes the limit groove 320 in a state opposite to the suspension member 610, the suspension member 610 can move toward the linkage gear 300 and eject and abut against the limit groove 320, to lock the linkage gear 300 on the base 900 to achieve a braking of the linkage gear 300. The ejection-push member 620, as a driving element of the suspension member 610, continuously provides a pushing and ejecting force to the suspension member, to push and eject the suspension member 610 toward the linkage gear 300, to be capable of pushing and ejecting the suspension member 610 into the limit groove 320 to eject and abut against the linkage gear 300 for braking.

It should be noted that, the suspension member 610, under an action of continuous pushing and ejecting force, always maintains a state of abutting against the linkage gear 300. During a rotation of the linkage gear 300, the suspension member 610 slides on the linkage gear 300. Only in a condition that the linkage gear 300 is rotated to a state in which the limit groove 320 is opposite to the suspension mechanism 600, the suspension member 610 moves and ejects and abuts into the limit groove 320 under the action of the pushing and ejecting force, to brake the linkage gear 300. The continuous pushing and ejecting force enables the suspension member 610 to track a position of rotating peripheral surface of the linkage gear 300 and respond to a rotating state of the limit groove 320 in a timely manner. That is, after the limit groove 320 and the suspension mechanism 600 are in corresponding positions, the suspension member 610 immediately ejects and abuts against and clamps the limit groove 320. An ejecting-abutting portion 611 may be disposed on the suspension member 610 for contacting, ejecting and abutting against the limit groove 320, and may be ejected and abutted into an interior of the limit groove 320 to implement contacting, ejecting and abutting for braking.

As shown in FIG. 18, in some embodiments, the limit groove 320 may be configured as a groove located on a peripheral surface of the linkage gear 300. Accordingly, the ejecting-abutting portion 611 of the suspension member 610 may be configured as a protruding portion that matches a groove shape of the groove and ensures that the ejecting-abutting portion 611 can be snapped and embedded into the groove and disengaged from the groove, to facilitate a smooth clamping for braking of the ejecting-abutting portion 611 and a releasing from braking of the ejecting-abutting portion 611.

It is worth noting that a notch of the groove may be provided with a jointing surface for smoothly jointing to a peripheral surface of the linkage gear 300, to facilitate the ejecting-abutting portion 611 to slide smoothly into the groove relative to the peripheral surface of the linkage gear 300 and be smoothly disengaged from the groove, and thus the braking and a releasing from braking can be both achieved smoothly and stably.

In some embodiments, a groove shape of the groove may be configured to be C-shaped or V-shaped, and accordingly, the ejecting-abutting portion 611 may also be configured to be an embeddable arc-shaped or spire-shaped structure.

In order to facilitate the ejecting-abutting portion 611 to be smoothly disengaged from the groove, a certain gap may be left between the ejecting-abutting portion 611 and the groove, that is, when the ejecting-abutting portion 611 is snapped and embedded in the groove, a portion of the ejecting-abutting portion 611 is ejected and abutted against an inner wall of the groove, and a gap is formed between another portion of the ejecting-abutting portion 611 and a groove wall of the groove. Therefore, under a premise of ensuring a clamping of the ejecting-abutting portion 611 and the groove, the ejecting-abutting portion 611, when subjected to a force slightly greater than the pushing and ejecting force, can also be smoothly disengaged from the groove.

As shown in FIG. 17 and FIG. 21, in some embodiments, it is considered that a stability of the pushing and ejecting force and a stability of acting effect of the pushing and ejecting force have a positive effect on a braking performance of the ejecting-abutting portion 611. A push-ejection limit slot 612 may be formed on the suspension member 610, and the ejection-push member 620 may be disposed in the push-ejection limit slot 612, to maintain a relatively stable connection state between the ejection-push member 620 and the suspension member 610. Thus an amplitude of relative swing between the ejection-push member 620 and the suspension member 610 can be reduced to a certain extent, to maintain stabilities of a direction of subjected force, a movement direction of the ejecting-abutting portion 611, and a contact area between the ejecting-abutting portion 611 and the limit groove 320, to ensure a braking effect. The ejection-push member 620 may also be directly connected to the ejecting-abutting portion 611 to concentrate an action point of the pushing and ejecting force on the ejecting-abutting portion 611, to reduce a risk of directional deviation of the pushing and ejecting force and an unstable ejecting-abutting effect due to changes in postures of the suspension member 610 itself.

It is worth noting that specifications of sizes of the push-ejection limit slot 612 and the ejection-push member 620 may be designed to match one another. The width of the push-ejection limit slot 612 may be slightly larger than a width of the ejection-push member 620, to reduce a space for relative swing to maintain a stability of direction of the pushing and ejecting force.

In some embodiments, a push-ejection limit slot 612 may be configured as a blind hole along a direction of the pushing and ejecting force and capable of accommodating the ejection-push member 620. A bottom of the push-ejection limit slot 612 is disposed on the ejecting-abutting portion 611 to form a limit along a circumferential direction for the ejection-push member 620, to limit a swing amplitude in the circumferential direction, reduce a risk of the suspension member 610 bouncing up under force, and ensure a stability of position and posture of ejection and push.

In some embodiments, an ejecting-abutting portion 611 is disposed at an end of the suspension member 610 for contacting, ejecting and abutting against the limit groove 320. A connecting portion may also be disposed at another end of the suspension member 610 for connecting the ejection-push member 620. Thus, a molding and processing of the suspension member can be facilitated, and a flow of processing can be simplified.

In some embodiments, the ejection-push member 610 may be configured as an elastic member, and thus a continuous and successive pushing and ejecting force is applied through an elastic deformation of the elastic member, to ensure that the suspension member 610 responds to the position changes of the rotating peripheral surface of the linkage gear 300 with a simple structure and high time efficiency, and can be quickly ejected and abutted into the limit groove 320 when the limit groove 320 is in place. At the same time, a stability of the elastic deformation of the elastic member enables the pushing and ejecting force applied to the suspension member 610 to maintain a stable state. On the one hand, a stability of a suspended state can be maintained, and on the other hand, the linkage gear 300 can also be enabled to be rotated to release a braking state under an action of a relatively stable and controllable driving force, to achieve a stability, a reliability of a suspension function and a performance for smooth implementation of the suspension function of the door opening and closing device.

It is considered that a deformation of the elastic member can be divided into a compressed deformation and a stretched deformation. The elastic member should be assembled in a way that can maintain a relatively stable and linear deformation state of the elastic member.

When the elastic member in a compressed state provides an elastic pushing and ejecting force, the suspension member 610 may be disposed between the elastic member and a peripheral surface of the linkage gear 300. The elastic member is compressed and disposed between the base 900 and the suspension member 610, and a reset direction of deformation of the elastic member is kept consistent with a direction of the pushing and ejecting force, to convert an elastic pushing force of the elastic member into a stable elastic pushing and ejecting force to output.

When the elastic member in a stretched state provides an elastic pushing and ejecting force, the elastic member can be stretched and disposed between the base 900 and the suspension member 610, and the reset direction of deformation of the elastic member is kept consistent with a direction of the pushing and ejecting force, to convert an elastic pulling force of the elastic member into a stable elastic pushing and ejecting force to output.

In some embodiments, the elastic member may be a spring and may be configured as a compression spring or a tension spring, to provide a stable pushing and ejecting force through a compressed deformation or a stretched deformation. The compression spring may be compressed between the suspension member and the base, or the tension spring may be stretched and connected between the suspension member and the base.

As shown in FIG. 20 and FIG. 21, a first end of the compression spring can be ejected and abutted against the ejecting-abutting portion 611. A boss portion 909 with a height substantially equal to that of the compression spring is disposed on the base 900. A second end of the compression spring can be ejected and abutted against the boss portion 909 to keep the compression spring in a straight posture in an axial direction thereof, to form a stable and reliable pushing and ejecting force.

In some embodiments, the first end of the tension spring may be fixed on a body of the ejection-push member 610, or directly fixed on the ejecting-abutting portion 611, and the second end of the tension spring may be fixed on the boss portion 909 that is disposed on the base 900. The tension spring should be kept flush with a plate surface of the base 900 and in a straight posture as much as possible to form a stable and reliable push-ejection force.

In some embodiments, a support groove 908 may be further disposed below the boss portion 909 to limit and support the above springs, to ensure a stability of ejecting and abutting position of the springs and avoid shaking.

In some embodiments, the elastic member may also be an elastic member such as a torsion spring, a leaf spring, etc., as long as a direction of elastic force of the elastic member is roughly consistent with a moving direction of the suspension member 610, which will not be repeated here.

In some embodiments, in order to maintain a stability of moving direction of the suspension member 610 and limit an excessive swing and vibration of the suspension member, a suspension limit slide groove 906 may be disposed on the base 900, and the suspension member may be disposed in the suspension limit slide groove 906. The stability of the moving direction of the suspension member 610 is maintained by a guiding and restraining effect of side walls of the suspension limit slide groove 906, to ensure a reliability of braking performance.

As shown in FIG. 20, in some embodiments, the suspension limit slide groove 906 may be configured as two opposite limit bosses 907. The limit bosses 907 may have a certain length in the moving direction of the suspension member 610, as long as the length can ensure that a limit for the suspension member 610 within a sliding stroke can be achieved. An upper limit structure may also be connected to a top of the two limit bosses 907 to limit the suspension member 610 from disengaging from the base to a certain extent. A corresponding upper limit structure may also be disposed and covered on the base 900. The upper limit structure is opposite to the suspension limit slide groove 906 to achieve a purpose of upper limit. Thus, the suspension member 610 can always move in a stable direction to ensure a reliability of braking performance.

In some embodiments, in order to maintain the stability of the moving direction of the suspension member 610 and limit an unstable swinging of the suspension member 610, the suspension member 610 may be configured as rod-shaped, and the ejecting-abutting portion 611 is disposed at an end of the suspension member 610 which is close to the linkage gear 300, that is, the suspension member 610 may be configured as a structural member with long strip shape having a certain length to cooperate with the suspension limit slide groove 906 to implement a stable sliding. A length characteristic of the long strip structural member and a radial limit effect of the suspension limit groove 906 on the long strip structural member can be utilized to reduce a swing amplitude to a certain extent. The longer a length in a direction of the pushing and ejecting force of the suspension limit slide groove 906 and a length of the rod-shaped suspension member 610 are, the better a performance of limiting the swing amplitude is, and the more stable the moving direction of the suspension member 610 is.

It is worth noting that, in a condition that the door body 13 is closed, an end of the door ejection member 520 is located in the limit groove 320, and the suspension mechanism 600 is abutted against and held on a peripheral surface of the linkage gear 300. In a condition that the linkage gear 300 is rotated, the linkage gear 300 pushes, through the door ejection surface 322, the door ejection member 520 to move relative to the base 900 to push the door body 13, and then drives the door rotation mechanism 400 to continue to rotate the door body 13. An end of the suspension mechanism 600 slides along the peripheral surface of the linkage gear 300, and thus when the suspension mechanism 600 slides into the limit groove 320, the suspension mechanism 600 is abutted against and held in the limit groove 320 to provide an acting force to brake the rotation of the linkage gear 300.

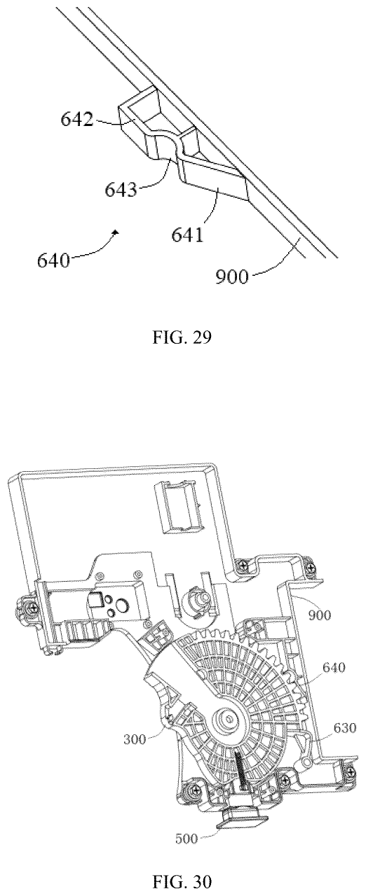

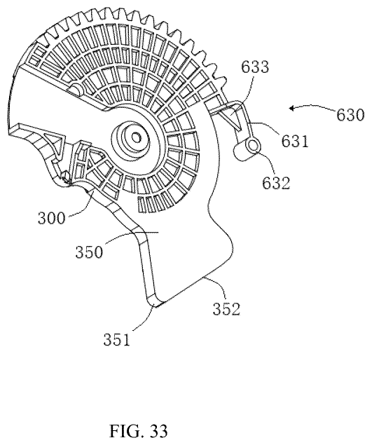

As shown in FIG. 28, FIG. 29, FIGS. 30 and 33, in some embodiments, in order to solve a problem that the door body 13 cannot maintain an opening when the door opening and closing device is shut down, a suspension structure 630 may be disposed on the linkage gear 300, and a limit mechanism 640 may be disposed on the base 900. In a condition that the linkage gear 300 rotates, the limit mechanism 630 rotates with the linkage gear 300, and thus when the linkage gear 300 rotates to a preset door opening position, the suspension structure 630 can engage with the limit mechanism 640 to lock the linkage gear 300 on the base 900, and thus the door rotation mechanism 400 is prevented from rotating the door body 13, to achieve a suspension of the door body 13 and maintain the door body 13 at a current position.

In some embodiments, the suspension mechanism 630 may include a connecting portion 631 and a suspension portion 632. The suspension portion 632 is connected to the linkage gear 300 through the connecting portion 631, and thus the suspension portion 632 can rotate with the linkage gear 300.

The suspension portion 632 serves as a functional portion that engages with the limit mechanism 640, and has a shape that can match that of the limit mechanism 640, and thus the suspension portion 632 and the limit mechanism 640, in a condition that they are in corresponding positions, can be smoothly engaged and form a certain degree of resistance force for disengagement, that is, a braking force for the linkage gear 300, to lock the linkage gear 300 on the base 900.

It is worth mentioning that an engagement state between the suspension portion 632 and the limit mechanism 640 is a reversible state. When an external driving force applied to the linkage gear 300 is greater than the braking force between the suspension portion 632 and the limit mechanism 640, the linkage gear 300 transmits the external driving force to the connecting portion 631 to force the suspension portion 632 to be disengaged from the limit mechanism 640, and the linkage gear 300 continues to rotate. The linkage gear 300 is released from a braking state, and can drive the door rotation mechanism 400 to rotate the door body 13 to be closed, or can further expand an opening of the door body 13.

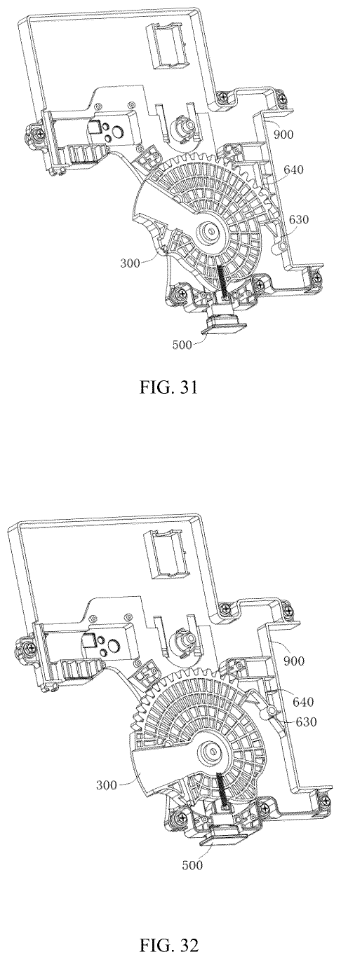

As shown in FIG. 29, FIG. 30, FIG. 31, FIG. 32 and FIG. 33, in some embodiments, the limit mechanism 640 may be configured as a limit portion 642 located on the base 900, for contacting and limiting the suspension portion 632 to form a certain resistance for movement, to brake the linkage gear 300. Furthermore, a retaining groove 643 may be formed on the limit portion 642. The suspension portion 632, when rotating to a position where the retaining groove 643 is located, can be naturally engaged in the retaining groove 643, to limit a disengagement of suspension portion 632 and form a braking force by accommodating or partially accommodating the suspension portion 632.

In some embodiments, in order to form a stable braking force for the linkage gear 300, the suspension portion 632 may be configured as an independent snapping-embedding member. A shape of the snapping-embedding member is configured to match a groove shape of the retaining groove 643. When the snapping-embedding member rotates to the position where the retaining groove 643 is located, a larger engagement contact surface can be formed. Thus, a friction resistance for disengagement can be improved to a certain extent, to form a relatively stable braking force, to be convenient for matching the driving force of the linkage gear 300 well. Thus, a smooth and stable control mode of driving and braking of the linkage gear 300 is formed. A stability and reliability of operating of the door opening and closing device are ensured.

In some embodiments, the snapping-embedding member may be configured as an elastically deformable member. When the snapping-embedding member is engaged in a groove body of the retaining groove 643, a certain elastic contact pressure is formed to enhance the braking force. In particular, when the snapping-embedding member is disengaged from the retaining groove 643, a further deformation is required to disengage from a notch of the retaining groove 643, to form a stable and reliable braking force.

It is worth mentioning that since the snapping-embedding member rotates with the linkage gear 300, a moving trajectory of the snapping-embedding member is arc-shaped. The retaining groove 643 may be disposed on the arc-shaped trajectory of the snapping-embedding member and biased to a side where a center of the linkage gear 300 is located. Therefore, when the snapping-embedding member rotates to the position where the retaining groove 643 is located, a certain deformation of the snapping-embedding member is required before the snapping-embedding member can be snapped and embedded into the retaining groove 643. Correspondingly, a certain deformation of the snapping-embedding member is required before the snapping-embedding member can be disengaged from the retaining groove 643, to facilitate a forming of a stable braking force.

In some embodiments, the snapping-embedding member may be configured as a hollow cylindrical member. A groove shape of the retaining groove 643 may also be configured as a shape that matches a cylindrical peripheral surface of the hollow cylindrical member, and thus a deformation direction of the hollow cylindrical member is mainly a radial direction of the hollow cylindrical member. A deformation area is a peripheral area in a length direction of the hollow cylindrical member. Thus, a regionalized stable deformation can be achieved, and a stable braking force can be ensured.

In some embodiments, the hollow cylindrical member may be a rubber member or members made of other materials that have a stable performance of elastic deformation. A specific elastic coefficient can be comprehensively configured as matching with arrangement positions of the retaining groove 543 and the suspension member 610 to ensure smooth operations of engagement and releasing engagement, and thus reduce a vibration and swing amplitude.

In some embodiments, the snapping-embedding member may be integrally formed with the connecting portion 631, to facilitate a processing of components and improving assembly efficiency. The connecting portion 631 may be fixed on the linkage gear 300 through a fixed connection mechanism, or may be integrally formed on the linkage gear 300.

In other embodiments, the snapping-embedding member may also be connected to the connecting portion 631 through a fixed connection structure, to easily implement a disassembling, assembling and replacement. Accordingly, the connecting portion 631 may be integrally formed with the linkage gear 300 to facilitate an overall assembly. The connecting portion 631 may also be fixed to the linkage gear 300 through a fixed connection structure to enrich connection ways and facilitate maintenance and replacement.

In some embodiments, in order to achieve a smooth suspension operation, the limit portion 642 may further include a guide portion 641 that is connected to a side of the limit portion 642. During the rotation of the linkage gear, the suspension portion may contact and move along the guide portion 641. The guide portion 641 can play a role of buffering and guiding to guide the suspension portion to smoothly engage into the retaining groove, to avoid the suspension portion from being unable to stably engage in the retaining groove due to inertia.

In some embodiments, the guide portion 641 may be configured as a guide plane which is tangent to a peripheral surface of the linkage gear 300. The retaining groove 643 is disposed at an end of the guide plane, and thus the suspension portion 632 contacts and moves along the guide plane, directly falls to be in position, and snapped and embedded into the retaining groove 643.

It is worth mentioning that a tangent point of the guide plane with the arc-shaped trajectory of the suspension portion 632 may be disposed at a notch of the limit groove. When the suspension portion 632 just contacts the guide plane, the suspension portion 632 after forming a certain contact pressure is immediately engaged into the limit groove. When the linkage gear 300 is to be released from the braking state, it is required to break through this contact pressure to form a stable ejecting and pushing force, to facilitate the driving mechanism of the linkage gear 300 to implement a stable controlling operation of driving.

In some embodiments, the connecting portion 631 may also be configured as an elastic connecting arm which is elastically deformable, and thus the suspension portion 632 can be smoothly and stably engaged into the limit groove through an elastic deformation of the elastic connecting arm. The suspension portion 632 can be disengaged from the limit groove under an action of a stable pressure force, to achieve smooth operations for braking and releasing from braking.

In order to ensure a reliability of the suspension structure 630, a length of the elastic connecting arm should not be too large to avoid an excessive deformation. The excessive deformation affects a state of subjected force of the suspension portion, resulting in that the suspension portion is unable to be stably engaged in the limit groove, or is easily disengaged from the limit groove, and thus a braking effect is deteriorated.

In some embodiments, a reinforcing rib plate 633 may be further disposed between the elastic connecting arm and the linkage gear 300 to reinforce a connection relationship and limit an excessive deformation of the elastic connecting arm to a certain extent.

In some embodiments, the connecting portion 631 may be made of a composite material and configured as a structure with gradually changed hardness and elasticity, to take into account a stable elastic deformation, a reliable structural strength and stability of form together, to ensure a stability of the subjected force and a braking effect of the suspension portion 632.

The door opening and closing device according to the embodiment of the disclosure realizes an automatic door opening and closing by driving the door rotation mechanism to rotate the door body 13 through the linkage gear which can be driven by a driving mechanism. The linkage gear 300 is rotated forward and reversely to drive the door rotation mechanism 400 to act to push and pull the door body 13, to implement a door opening and closing. A limit groove 320 is disposed on the linkage gear 300 to match the suspension mechanism 600 disposed on the base 900 to form a functional suspension structure which serves as a functional structure for braking the linkage gear 300. The suspension mechanism 600 tracks positions of rotating peripheral surface of the linkage gear 300. In a condition that the linkage gear 300 is rotated to a preset suspension position, the suspension mechanism 600 is abutted against and held in the limit groove 320 to lock the linkage gear 300 on the base 900 to realize a braking of the linkage gear, to brake the door rotation mechanism 400 connected to the linkage gear 300. Thus, a suspension of the door body 13 is realized. An opening stability of the door body 13 is ensured. Thus it is easy to use while a door-opening difficulty is reduced. A risk of collision is reduced. At the same time, the limit groove 320 has the multiple functions, and a door ejection surface 322 and a door ejection mechanism 500 are provided, During the rotation of the linkage gear 300, the door ejection mechanism 500 is ejected and pushed to push a movement of the door body 13, to break through door-opening resistance forces such as an adsorption force of the door body 13 and the like. Thus, it is convenient for the door rotation mechanism 400 to rotate the door body 13 and reduce the door opening and closing difficulty.

As shown in FIG. 1 and FIG. 2, in some embodiments, the door rotation mechanism 400 may include a front connecting rod 410 and a rear connecting rod 420 which are in a hinged connection at ends. Another end of the front connecting rod 410 is rotatably connected to the door body 13 at a first connection point 432. The front connecting rod 410 is disposed between a bottom surface of the linkage gear 300 and the base 900. The rear connecting rod 420 is deflectably disposed in an installation groove 360 which is formed on a top surface of the linkage gear 300. Another end of the rear connecting rod may be rotated coaxially with the rotation center 310 of the linkage gear 300, and the rear connecting rod 420 and the linkage gear 300 are connected to the base 900 at the rotation center 310 of the linkage gear 300, that is, the rear connecting rod 420 can be rotated with the linkage gear 300, and thus the front connecting rod 410 is pushed and pulled under pushes of a first abutting-holding surface 361 and a second abutting-holding surface 362 oppositely formed on groove walls of the installation groove 360 to rotate the door body 13, to implement operations of door opening and closing.

It is worth mentioning that the front connecting rod 410 and the rear connecting rod 420 are respectively disposed on two sides of the linkage gear 300, that is, reserved spaces at two sides along a thickness direction of the linkage gear 300 which is rotatably supported on the base 900 can be utilized for disposing the front connecting rod 410 and the rear connecting rod 420 respectively without occupying a space above the linkage gear 300, to reduce a space requirement of the door rotation mechanism 400 in a thickness direction to a certain extent. The rear connecting rod 420 is sunken and disposed in the installation groove 360, to make an overall assembly height of the door rotation mechanism 400 and the linkage gear 300 not be excessively higher than a height of the linkage gear 300, and even be the same. Overall, a thickness of the door opening and closing device 11 can be reduced by disposing the front connecting rod 410 and the rear connecting rod 420 at the two sides respectively and using the installation groove 360.

In some embodiments, the front connecting rod 410 and the rear connecting rod 420 can also be disposed in a space below the linkage gear 300 and is located above the base 900. The installation groove 360 is also disposed on a bottom surface of the linkage gear 300, to reduce an overall thickness of the door opening and closing device 11 as a whole.

As shown in FIG. 1, in some embodiments, the door rotation mechanism 400, the driving mechanism 100 and the clutch-ejection-push assembly 240 may be disposed on a same side of a line connecting the clutch 200 and the linkage gear 300, to improve a compactness of overall structure to a certain extent. Thus, a width of overall lateral layout can be relatively reduced, to implement a miniaturization of the door opening and closing device 11. Thus, the door opening and closing device 11 have a good installation compatibility, to facilitate an installation on a refrigerator and reduce an interference with the refrigerator and surrounding environment of the refrigerator.

In some embodiments, the door body 13 and the box body 12 are rotatably connected at a first connection point 432. The front connecting rod 410 and the door body 13 are connected at a second connection point 434. The rear connecting rod 420 and the front connecting rod 410 are rotatably connected at a third connection point 436. The linkage gear 300 has a rotation center 438. The second connection point 434 and the third connection point 433 are respectively located on two sides of a line connecting the first connection point 432 and the rotation center 438, and thus points of force application of two connecting rods are respectively located on two sides of the above-mentioned line. When deformation due to force occurs on the two connecting rods, deformation directions or trends of the two connecting rods will be in two opposite directions of a rod body, to avoid a deviation to a same side and maintain a balance at a stable interface. Thus, a stable structure for force application can be obtained, and an excessive deformation can be prevented from affecting an overall shape stability of the door opening and closing device.

In some embodiments, an angle between a first connecting line which connects the output gear 120 with the first transmission gear 212 and the second connecting line which connects the second transmission gear 222 with the linkage gear 300 may be controlled to range from 90 to 120 degrees, and thus the driving mechanism 100, the door rotation mechanism 400 and the clutch-ejection-push assembly 240 disposed on a same side all have sufficient installation space.

The door rotation mechanism 400 may be disposed in an area enclosed by the first connecting line, the second connecting line and the door body.

In some embodiments, since the entire front connecting rod 410 and a portion of the rear connecting rod 420 rotate in the air and may not directly contact or be connected to other structures, a corresponding base structure may not be provided in an area swept by the entire front connecting rod 410, and thus the front connecting rod 410 can be disposed outside an area where the base 900 is located. On the one hand, a material consumption of the base 900 is reduced, and on the other hand, a fixing structure for the base 900 can be kept away from functional portions, such as a wiring area in an edge area of an electrical apparatus and the like, to a certain extent, to achieve a good installation compatibility and adaptability to an environment.

In some embodiments, the driver 110 may be fixed on the base 900, and the output gear 120 may be disposed above the driver 110 with a certain installation height, and thus the first transmission gear 212 and the output gear 120 may be disposed side by side at a same height. Accordingly, the second transmission gear 222 and the linkage gear 300 are disposed side by side at a same height. The second transmission gear 222 is located below the first transmission gear 212, to make full use of a thickness space and the width space as a whole for an arrangement and coordination, and thus an overall thickness and width are at a relatively low level, to be convenient for a miniaturization of the door opening and closing device.

As shown in FIG. 1, in some embodiments, in order to accurately control a rotation stroke of the linkage gear 300, an angle acquisition unit 800 may be disposed on the linkage gear 300 to detect a rotation angle of the linkage gear 300 as a parameter of feedback control for a field controller to control actions of the driving mechanism 100 and the clutch 200. Usually, an angle detection sensor or the like may be used and directly assembled on the linkage gear 300. Of course, other types of angle sensors can also be used, and will not be listed here.

An electrical apparatus is also provided according to an embodiment of the disclosure, including a door body 13, a box body 12 and the above-mentioned door opening and closing device. In a condition that the clutch 200 establishes a transmission connection state between the linkage gear 300 and the driving mechanism 100, the driving mechanism 100 can drive the linkage gear 300 to rotate, to drive the door ejection mechanism 500 to eject the door body 13 open, and then the door body 13 is rotated by the door rotation mechanism 400.

Generally speaking, electrical apparatuses may be dishwashers, single-door refrigerators, double-door refrigerators, and the like.

In addition, various embodiments can be combined with one another, but the combined embodiments must be based on that they can be implemented. When the combined embodiments are contradictory or cannot be realized, it should be considered that such combined embodiments do not exist, and are not within the protection scope sought for by the disclosure.

Although embodiments of the disclosure have been shown and described, it will be appreciated that various changes, modifications, substitutions and alterations may be made to the embodiments without departing from the principles and spirit of the disclosure, the scope of which is defined by the claims and equivalents thereof.

1. A door opening and closing device, comprising:
a driving mechanism;
a linkage gear rotatably disposed on a base;
a clutch disposed between the driving mechanism and the linkage gear, and configured to selectively make the driving mechanism and the linkage gear in transmission connection;
a door rotation mechanism, an end of which is connected to the linkage gear and another end of which is connected to a door body; and
a door ejection mechanism connected to the linkage gear and configured to push and eject the door body;
wherein, in a condition that the clutch makes the driving mechanism and the linkage gear in transmission connection and the driving mechanism drives the linkage gear to rotate, the linkage gear drives the door ejection mechanism to push the door body to eject the door body open, and then drives the door rotation mechanism to continue to open the door body.

2. The door opening and closing device according to claim 1, wherein the clutch comprises:
a first transmission assembly connected to the driving mechanism;
second transmission assembly connected to the linkage gear;
a transmission connection assembly connected to the second transmission assembly, and separably connected to the first transmission assembly; and
a clutch-ejection-push assembly comprising an ejection-push sleeve connected on the transmission connection assembly and a push rod for pushing the ejection-push sleeve-wherein the ejection-push sleeve is pushed by the push rod, to push the transmission connection assembly to be separated from or connected to the first transmission assembly. cm 3. The door opening and closing device according to claim 2, wherein the transmission connection assembly is movably connected on the second transmission assembly;
transmission connection assembly comprises a connecting end connected to the second transmission assembly and separably connected to the first transmission assembly, and an ejection-push end connected to the ejection-push sleeve,
wherein the first transmission assembly is a first transmission gear, the second transmission assembly being a second transmission gear, wherein an engaging groove is formed on an axial end surface of the first transmission gear close to the second transmission gear, the connecting end being separably engaged in the engaging groove,
wherein an engaging hole is formed on the second transmission gear, the connecting end being movably embedded in the engaging hole,
wherein the connecting end comprises at least on connecting arm, the at least one connecting arm being movably embedded in the engaging hole,
the ejection-push end comprises an annular seat that is fixedly connected to the at least one connecting arm and is rotatably connected on the ejection-push sleeve,
wherein the ejection-push sleeve comprises a push-ejection portion and a shaft sleeve portion connected to the push-ejection portion, the annular seat being sleeved on the shaft sleeve portion.

4-7. (canceled)

8. The door opening and closing device according to claim 3, wherein the clutch further comprises a separation assembly that is respectively connected to the transmission connection assembly and the second transmission assembly to provide an action force for driving the connecting end to be separated from the first transmission assembly.

9. The door opening and closing device according to claim 3, wherein the separation assembly comprises an elastic reset member, two ends of which are respectively connected to the transmission connection assembly and the second transmission assembly to provide an elastic action force for driving the connecting end to be separated from the first transmission assembly.

10. The door opening and closing device according to claim 3, wherein the clutch further comprises a separation assembly that is respectively connected to the transmission connection assembly and the base to provide an action force for driving the connecting end to be separated from the first transmission assembly.

11. The door opening and closing device according to claim 10, wherein the separation assembly comprises a first separation member and a second separation member which maintain magnetic action forces to each other, the first separation member being connected on the transmission connection assembly and the second separation member being connected on the base , to provide a magnetic action force for driving the connecting end to be separated from the first transmission assembly.

12. A door opening and closing device according to claim 2, wherein the ejection-push sleeve ejects and pushes the transmission connection assembly along a first direction, a first ejection-push surface being disposed on the ejection-push sleeve, a second ejection-push surface for contacting the first ejection-push surface is disposed on the push rod, wherein an angle between the first direction and the first ejection-push surface is an acute angle.

13. The door opening and closing device according to claim 12, wherein the clutch-ejection-push assembly further comprises a linear driver, wherein the linear driver is connected to the push rod to drive the push rod 42) to eject and push the ejection-push sleeve.

14. The door opening and closing device according to claim 2, wherein the clutch-ejection-push assembly further comprises a push-rod shock-absorbing pad that is disposed between the push rod and the base,
wherein the clutch-ejection-push assembly further comprises an anti-rotation mechanism that is disposed on the base and is snapped and embedded in the ejection-push sleeve to stop a rotation of the ejection-push sleeve,
wherein the clutch further comprises a stop assembly comprising a connecting member and a stop member, an end of the connecting member being fixed on the base, the first transmission assembly and the second transmission assembly being disposed on the stop connecting member, the stop member being fixed to another end of the stop connecting member to block the first transmission assembly and the second transmission assembly,
wherein the connecting member comprises a connect shaft, an end of which is fixed on the base, wherein the first transmission assembly, the second transmission assembly and the ejection-push sleeve are sleeved on the connecting shaft, and wherein the stop member comprises a baffle, the baffle being fixed to another end of the connecting shaft,
wherein the stop assembly is a bolt, the connecting shaft being a screw rod of the bolt, baffle being a bold head of the bolt.

15-18. (canceled)

19. The door opening and closing device according to claim 1, wherein a door ejection portion is disposed on a peripheral surface of the linkage gear, wherein the door ejection mechanism comprises a door ejection member that is movably disposed on the base, wherein in a condition that the driving mechanism drives the linkage gear to rotate, the door ejection portion is able to rotate with the linkage gear to push the door ejection member to move relative to the base, to make the door ejection member to eject the door body open.

20. The door opening and closing device according to claim 19, wherein the door ejection portion has an door ejection surface, wherein in a condition that the door ejection portion rotates with the linkage gear, the door ejection surface abuts against and holds the door ejection member to be able to push the door ejection member to move relative to the base, to make the door ejection member to eject the door body open, and
wherein the door ejection surface is gradually extended in a direction away from a rotation center of the linkage gear.

21. (canceled)

22. The door opening and closing device according to claim 20, further comprising an elastic member, wherein the elastic member is connected between the base and the door ejection member, and wherein in a condition that the door ejection member is disengaged from cooperating with the door ejection surface, the elastic member is able to drive the door ejection member to follow a movement of an avoidance surface, and is able to reset the door ejection member.

23. The door opening and closing device according to claim 22, wherein the elastic member is one of a spring and a torsion spring.

24. The door opening and closing device according to claim 22, wherein the door ejection portion further comprises an avoidance surface, the avoidance surface being connected to the door ejection surface, and wherein after the door ejection member is disengaged from abutting and holding with the door ejection surface, the door ejection member is able to be reset and follow the avoidance surface.

25. The door opening and closing device according to claim 24, wherein the door ejection surface and the avoidance surface are connected at a connection point, and wherein a distance between the connection point and a rotation center of the linkage gear is greater than a distance from any point on the avoidance surface and the door ejection surface to the rotation center of the linkage gear.

26. The door opening and closing device according to claim 19, further comprising a suspension mechanism, the suspension mechanism being movably disposed on the base, a limit groove being formed on the linkage gear, wherein in a condition that the linkage gear rotates to a state in which the limit groove is opposite to the suspension mechanism, the suspension mechanism moves, and ejects and abuts into the limit groove to brake the linkage gear.

27. The door opening and closing device according to claim 26, wherein the suspension mechanism comprises a suspension member and an ejection-push member;
ejection-push member is disposed on the base, and the suspension member is movably disposed on the base, wherein the suspension member is connected to the ejection-push member, and an ejecting-abutting portion that is disposed on the suspension member abuts against the linkage gear;
in a condition that the linkage gear is rotated to a state in which the limit groove is opposite to the suspension mechanism, the ejection-push member pushes the suspension member to move, to make the ejecting-abutting portion to be ejected and abutted into the limit groove.

28. The door opening and closing device according to claim 27, wherein the ejection-push member is an elastic member, an end of the elastic member being connected to the base, another end of the elastic member being connected to the suspension member, the elastic member being elastically compressed or stretched between the base and the suspension member.

29. The door opening and closing device according to claim 26, wherein a suspension limit slide groove is formed on the base, a suspension member being slidably embedded in the suspension limit slide groove, and wherein an elastic member is disposed in the suspension limit slide groove, with an end ejecting and abutting against the base and another end ejecting and abutting against the suspension member, and
wherein the door ejection portion is disposed in the limit groove.

30. (canceled)

31. The door opening and closing device according to claim 1, wherein the door rotation mechanism comprises a front connecting rod and a rear connecting rod which are in a hinged connection at ends, another end of the front connecting rod being connected to the door body another end of the rear connecting rod being deflectably disposed in an installation groove which is formed on the linkage gear and wherein the linkage gear is driven to rotate by the driving mechanism to drive the rear connecting rod to push or pull the front connecting rod to push or pull the door body,
wherein the front connecting rod is located below a bottom surface of the linkage gear, the rear connecting rod being located in the installation groove that is located on a top surface of the linkage gear, or wherein the installation groove is located on the bottom surface of the linkage gear, the front connecting rod and the rear connecting rod being both located below the bottom surface of the linkage gear, wherein the door body and a box body are rotatably connected at a first connection point, and wherein the front connecting rod and the door body are connected at a second connection point, and
wherein the rear connecting rod and the front connecting rod are rotatably connected at a third connection point, the linkage gear having a rotation center, the second connection point and the third connection point being respectively located on two sides of a line connecting the first connection point and the rotation center.

32-33. (canceled)

34. An electrical apparatus, comprising a door body, a box body and the door opening and closing device according to claim 1, wherein in a condition that the clutch establishes a transmission connection state between the linkage gear and the driving mechanism, the driving mechanism is able to drive the linkage gear to rotate, to drive the door ejection mechanism to eject the door body open, and then the door body is rotated by the door rotation mechanism.
